(19) United States
(12) Patent Application Publication
(10) Pub. No.: US 2026/0290078 A1
(43) Pub. Date: Sep. 24, 2026

(54) SYSTEM

(71) Applicant: SoftBank Group Corp., Tokyo (JP)

(72) Inventor: Toru ASANO, Tokyo (JP)

(73) Assignee: SoftBank Group Corp., Tokyo (JP)

(21) Appl. No.: 19/564,277

(22) Filed: Mar. 12, 2026

(30) Foreign Application Priority Data
Mar. 19, 2025 (JP) 2025-044951

(51) Int. Cl. G06V 40/20; G06F 40/40; G06V 10/26; G06V 10/764; G06V 10/776; G06V 10/82; G10L 25/63

(52) U.S. Cl. CPC G06V 40/20; G06F 40/40; G06V 10/26; G06V 10/764; G06V 10/776; G06V 10/82; G10L 25/63

(57) ABSTRACT

A system includes a processor that is configured to: analyze expressions and behaviors of children by using image recognition technology and emotion analysis technology to detect a possibility of bullying, generate a warning message and adjust contents of the warning message by using a generative AI model, and provide concrete countermeasures based on an analysis result to guardians and educational personnel.

### CROSS-REFERENCE TO RELATED APPLICATION

This application is based on and claims priority under 35 USC 119 from Japanese Patent Application No. 2025-044951 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional techniques for monitoring school environments and home environments rely heavily on manual observation by guardians and educational personnel. Such techniques are prone to oversight because bullying behaviors often occur in brief, subtle, or concealed forms that are difficult to detect in real time. Additionally, known monitoring systems that merely record video or send unfiltered alerts cannot reliably distinguish between normal child play and actual bullying, leading to false alarms that reduce the credibility and usability of the system. Furthermore, conventional systems do not provide sufficiently tailored guidance to guardians and educational personnel on how to respond when a potential bullying situation is detected, and they typically lack mechanisms to continuously improve detection accuracy based on newly collected data and feedback. Therefore, there is a need for a system that can objectively and automatically analyze children's expressions and behaviors, detect the possibility of bullying with improved accuracy, generate appropriate warning messages with adjusted content, and provide concrete countermeasures in a form that is easily accessible and practically useful for guardians and educational personnel, while also enabling continuous self-learning to enhance performance over time.

### SUMMARY

In order to solve the above-described problems, an aspect of the invention provides a system comprising a processor, wherein the processor is configured to analyze expressions and behaviors of children by using image recognition technology and emotion analysis technology to detect a possibility of bullying. The processor is further configured to generate a warning message and to adjust contents of the warning message by using a generative AI model so that the warning message is adapted to the context of the detected situation and to the role of the recipient, such as a guardian or educational personnel. Additionally, the processor is configured to provide concrete countermeasures based on an analysis result to guardians and educational personnel, for example by presenting specific recommendations for communication with the child, strengthening of monitoring structures at school, or consultation with counseling resources. In some embodiments, the processor is configured to provide a dashboard that presents analysis results of the expressions and behaviors of the children to the guardians and the educational personnel and to allow the guardians and the educational personnel to view information through an accessible interface. In further embodiments, the processor is configured to perform self-learning by using newly collected data, to periodically evaluate a model in order to improve detection accuracy of the possibility of bullying, and to form a feedback loop for accuracy improvement, thereby enabling the system to refine its detection and reduce false positives and false negatives over time.

The term “processor” refers to any hardware and/or software component, including one or more CPUs, GPUs, ASICs, FPGAs, microcontrollers, and associated memory and control logic, that executes instructions to perform functions described in the present disclosure.

The term “image recognition technology” refers to a technique or set of techniques that processes image data to automatically detect, identify, or classify objects, persons, faces, poses, or other visual features appearing in the image.

The term “emotion analysis technology” refers to a technique or set of techniques that estimates emotional states, such as fear, sadness, anger, happiness, or neutrality, from input data including facial expressions, body posture, or other observable behavioral cues.

The term “expressions and behaviors of children” refers to visual and behavioral characteristics of children, including but not limited to facial expressions, eye gaze, body posture, gestures, movement patterns, and interactions with other persons as captured in image data or video data.

The term “possibility of bullying” refers to a likelihood, probability, or risk level that a particular situation or interaction among children corresponds to bullying behavior, as determined by analysis performed by the system.

The term “generative AI model” refers to an artificial intelligence model, such as a neural network-based generative model or large language model, that is capable of generating text or other content, including warning messages, based on input data and contextual information.

The term “warning message” refers to a notification generated by the system, including textual content and optionally metadata, that informs a recipient about a detected possibility of bullying and may include a description of the situation, severity, and recommended actions.

The term “contents of the warning message” refers to the specific information included in the warning message, such as the time and place of the detected event, a description of the children's expressions and behaviors, the assessed likelihood of bullying, and recommended countermeasures.

The term “analysis result” refers to data produced by the processor through processing of image data and other inputs, including detection outcomes, emotional state estimates, interaction patterns among children, and calculated bullying probabilities or risk scores.

The term “concrete countermeasures” refers to specific and actionable recommendations or instructions provided to a recipient, such as guidance for communicating with a child, monitoring particular locations or relationships, or engaging counseling or other support resources.

The term “guardians” refers to persons who have legal or de facto responsibility for the care, supervision, or welfare of children, including parents, foster parents, and legal guardians.

The term “educational personnel” refers to persons involved in the education or supervision of children in an educational setting, including teachers, school administrators, counselors, and other school staff.

The term “dashboard” refers to a graphical or textual user interface screen or set of screens that aggregates, organizes, and displays analysis results and related information in a structured manner for viewing by guardians and educational personnel.

The term “interface” refers to any hardware and/or software mechanism through which a user can access the dashboard or other functions of the system, including but not limited to a web interface, mobile application, desktop application, or dedicated terminal interface.

The term “newly collected data” refers to data acquired by the system after initial deployment, including additional image data, updated analysis results, user feedback, labels indicating correctness or incorrectness of previous detections, and any other related contextual information.

The term “self-learning” refers to a process in which the system automatically updates or adapts its internal models or parameters based on newly collected data, without requiring complete manual redesign of the model.

The term “periodically evaluate a model” refers to repeatedly assessing the performance of a detection model at predetermined or dynamically determined intervals, using evaluation data and metrics such as accuracy, precision, recall, false positive rate, or false negative rate.

The term “feedback loop for accuracy improvement” refers to a process in which outputs or performance metrics of the model, including user feedback and evaluation results, are fed back into a training or adjustment process to refine the model and improve detection accuracy over time.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

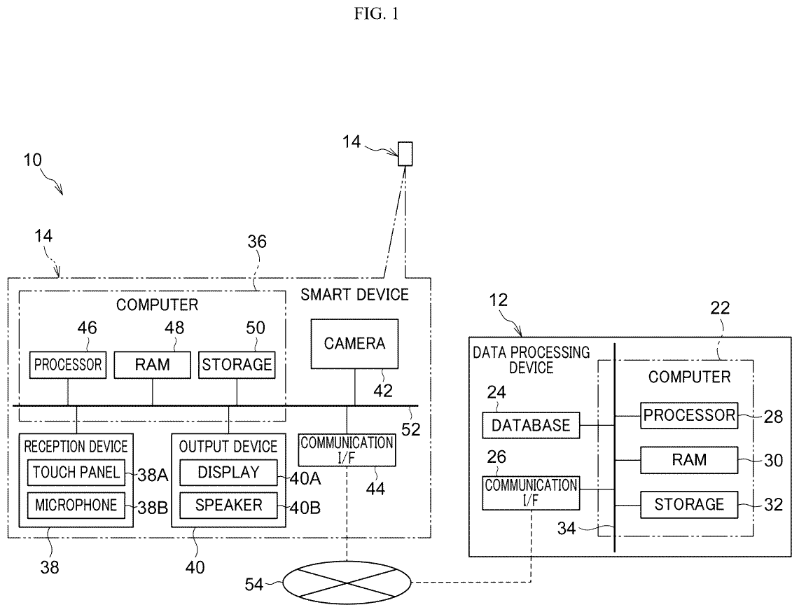

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

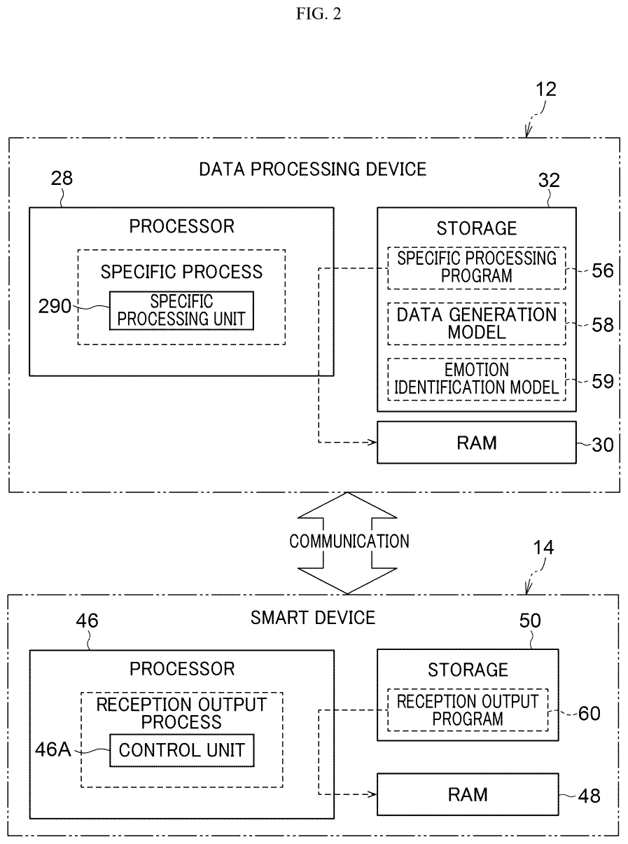

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented monitoring systems for detecting problematic behavior among children largely rely on simple thresholding of isolated sensor signals, such as single-frame image classification or coarse motion detection. Such systems typically apply fixed image recognition pipelines to individual frames, and then generate static alarm messages whenever a local score exceeds a preset threshold. As a result, these systems suffer from several technical limitations.

First, conventional systems are not configured to temporally integrate heterogeneous visual features, such as facial expressions and body motions, across multiple subjects over time. Processing units in such systems generally perform per-frame or per-subject inference without constructing interaction-level feature representations. This causes the processing units to produce noisy or unstable bullying likelihood scores, increases false positives and false negatives, and overloads communication and storage resources due to redundant or low-value alerts.

Second, conventional systems lack an integrated mechanism to automatically transform structured machine-readable analysis results into context-aware natural language guidance. In existing architectures, application servers output raw model scores and generic fixed-form messages. Human operators must manually interpret these low-level outputs and draft appropriate responses, which leads to latency, inconsistent handling, and poor scalability. In particular, the absence of a systematic process for generating semantically rich prompt sentences from structured data and using a generative AI model to derive tailored countermeasures results in inefficient use of computing resources and underutilization of the analytical capabilities of the underlying models.

Third, conventional systems are not designed with a closed feedback loop that uses user feedback as labeled training signals to refine both a discrimination model and a prompt-generation process. Data processing units in known systems may log events, but they generally do not associate detailed feedback with specific multimodal analysis results in a way that can be programmatically exploited to retrain models or to adjust thresholds. Consequently, the systems do not automatically adapt to new environments, camera placements, or behavioral patterns, and cannot systematically reduce error rates over time. This leads to suboptimal model performance, unstable alerting behavior, and degraded user trust.

Fourth, existing dashboards and user interfaces are often ad hoc and not optimized for handling complex, temporally indexed analysis results. Information is typically exposed as isolated lists of alerts or raw video links, without a coherent time-series aggregation or direct linkage between analysis results, generated natural language guidance, and underlying evidence frames. As a result, guardians and educational personnel must manually correlate timestamps, messages, and video segments, leading to inefficient use of processing resources on both client and server devices and increased cognitive load on users.

Accordingly, there is a need for an improved computer-implemented system and server-side architecture that: (i) robustly integrates facial expression analysis, posture estimation, and motion recognition across time and across multiple subjects to compute a stable risk index for a possibility of bullying; (ii) automatically generates structured prompt sentences from the analysis results and leverages a generative AI model to produce context-sensitive warning messages and concrete countermeasures; (iii) forms a feedback-driven learning loop that uses user inputs as training data to update both a discrimination model and a prompt generation process; and (iv) provides a time-series management interface that consistently links analysis results, generated notifications, and underlying imaging information. Such improvements constitute a technical advancement in computer-based analysis and decision support systems by enhancing the quality, stability, and adaptability of automated bullying detection and response generation while reducing unnecessary alerts and operator workload.

The specific processing by the specific processing unit 290 of the data processing device 12 in Example 1 is realized by the following means.

The present invention provides a server comprising a processor configured to receive imaging information from an image acquisition device, extract facial regions and body regions of subjects from the imaging information, perform expression analysis processing on the facial regions, perform posture estimation processing and motion recognition processing on the body regions, temporally integrate feature quantities relating to interactions between the subjects based on results of the expression analysis processing, the posture estimation processing, and the motion recognition processing, and calculate a risk index related to a possibility of bullying; generate, when the risk index satisfies a predetermined criterion, structured data describing a situation, create a natural language prompt sentence from the structured data, input the prompt sentence to a generative AI model, and generate notification information including a warning message and concrete countermeasures based on a response from the generative AI model; transmit the notification information to a user display device and cause the user display device to display at least the warning message, the concrete countermeasures, and a summary of analysis results; and associate feedback information input by a user with the analysis results, record the feedback information and the analysis results, and perform a learning process that periodically updates at least one of a discrimination model for calculating the risk index and processing for generating the prompt sentence, based on the recorded information. This enables a computer-implemented monitoring system to compute more accurate and stable bullying-related risk indices by integrating multimodal, time-series interaction features; to automatically convert internal structured analysis outputs into context-aware natural language guidance using the generative AI model; and to adaptively improve both discrimination and prompt-generation performance over time through a feedback-driven learning loop, thereby reducing false alarms, improving relevance of alerts and countermeasures, and enhancing overall efficiency and technical capability of the monitoring system.

The term “image acquisition device” refers to a hardware apparatus configured to capture imaging information of a subject, including but not limited to a camera, an image sensor module, or a multifunction terminal having an image capturing function.

The term “imaging information” refers to digital data representing visual information of a scene, including still image data, moving image data, or a sequence of image frames obtained by the image acquisition device.

The term “communication path” refers to a logical or physical communication channel through which data is transmitted between devices, including wired or wireless networks and associated communication protocols.

The term “information processing apparatus” refers to an electronic computing system including at least one processor and a memory, configured to execute programs for analyzing imaging information and generating control or notification data.

The term “facial region” refers to a portion of imaging information corresponding to at least a face of a subject, which is extracted or identified by image analysis processing.

The term “body region” refers to a portion of imaging information corresponding to at least a torso or limbs of a subject, excluding or including the facial region, which is extracted or identified by image analysis processing.

The term “expression analysis processing” refers to computational processing that analyzes the facial region to derive information related to an emotional state or affective expression of a subject.

The term “posture estimation processing” refers to computational processing that estimates positions or orientations of body parts of a subject, including joint locations or body pose, based on the body region in the imaging information.

The term “motion recognition processing” refers to computational processing that classifies or identifies actions or behaviors of a subject over time based on changes in the facial region, the body region, or both.

The term “feature quantities relating to interactions between subjects” refers to numerical or symbolic values representing characteristics of spatial or temporal relationships among multiple subjects, including proximities, repeated actions, directional movements, and co-occurring emotional states.

The term “risk index related to a possibility of bullying” refers to a quantitative or categorical indicator, computed by the information processing apparatus, that represents a likelihood or severity of bullying-related behavior in a monitored scene.

The term “structured data describing a situation” refers to machine-readable data that encodes at least analysis results, temporal information, and subject-related information in a predetermined format, such as a record, a table, or a data object.

The term “natural language prompt sentence” refers to a text string expressed in a human language that is generated from the structured data and used as an input condition or instruction to a generative AI model.

The term “generative AI model” refers to a machine learning model configured to generate text or other content in response to an input, including but not limited to a neural network that produces a response sentence based on the natural language prompt sentence.

The term “response sentence” refers to natural language text generated by the generative AI model in response to the prompt sentence and including at least a warning content or a countermeasure content.

The term “notification information” refers to data that includes a warning message, concrete countermeasures, or related analysis information, and that is intended to be presented to a user via a user display device.

The term “warning message” refers to a part of the notification information that informs a user of the presence or likelihood of bullying-related behavior or an abnormal condition.

The term “concrete countermeasures” refers to specific recommended actions or procedures that a user may take in response to the warning message, generated based on the response sentence from the generative AI model.

The term “user display device” refers to a terminal apparatus configured to present information to a user via a display unit, including but not limited to a smartphone, a tablet, a personal computer, or a dedicated monitor.

The term “summary of analysis results” refers to a condensed representation of detailed analysis outputs, including at least a risk index and key detected behaviors or emotional states, suitable for display to a user.

The term “feedback information” refers to data input by a user that evaluates, confirms, corrects, or supplements the notification information, the warning message, the countermeasures, or the analysis results.

The term “discrimination model” refers to a computational model, such as a machine learning classifier, that receives input feature quantities and outputs the risk index or a related classification result.

The term “learning process” refers to a sequence of computational operations for adjusting parameters of at least the discrimination model or a prompt generation process based on training data including past analysis results and feedback information.

The term “training data” refers to data used in the learning process and including at least expression analysis results, motion recognition results, risk indices, notification information, and feedback information associated with imaging information.

The term “model configuration” refers to structural or parametric settings of the discrimination model or another machine learning model, including but not limited to the number of layers, types of layers, or internal parameter values.

The term “threshold” refers to a predetermined numerical or logical value used to determine whether a computed metric, such as a risk index or an evaluation index, satisfies a criterion for triggering a specific operation.

The term “evaluation index of the discrimination model” refers to a performance metric that quantitatively evaluates accuracy, precision, recall, loss, or similar performance of the discrimination model on validation or feedback data.

The term “condition for issuing the warning message” refers to one or more logical or numerical criteria, including the threshold and the risk index, that determine whether the notification information including the warning message is generated and transmitted.

The term “contents of generation of the prompt sentence” refers to at least structure, wording, level of detail, or contextual constraints applied when converting structured data into the natural language prompt sentence.

In one embodiment, a terminal and a server cooperate to implement a bullying-risk detection and guidance system. The terminal includes at least one processor, a memory, a network interface, and an image acquisition device such as a digital camera or an image sensor module integrated in a mobile terminal. The server includes at least one processor, a main memory, a persistent storage device, a network interface, and optionally an accelerator such as a graphics processing unit.

The terminal acquires imaging information by directly controlling the image acquisition device via operating system interfaces. For example, the terminal uses a camera framework of a mobile operating system or a driver of a universal serial bus camera to set an image resolution, a frame rate, and an encoding format. The terminal converts raw sensor outputs into digital image frames in a standardized color format and encapsulates the frames into a video stream or a sequence of compressed images. The terminal then establishes a secure communication session with the server using a transport layer security protocol and transmits the imaging information to the server via a communication path. The terminal may attach metadata including a camera identifier, a location identifier, and timestamps in a structured header format.

The server receives the imaging information through a web application module implemented on the processor. The server stores incoming data into a buffer region in memory and writes longer sequences to the storage device as needed. The server uses an image processing library to decode compressed video data into individual frames and converts the frames into a unified numerical representation, such as multi-dimensional arrays of pixel intensity values. The server then performs image normalization operations, including resolution scaling, mean subtraction, and variance normalization, to prepare inputs for subsequent models.

The server detects facial regions and body regions on each frame by applying a detection model to the normalized image arrays. In one example, the server executes a convolutional neural network configured for object detection. The model receives an image tensor as input and outputs bounding boxes and confidence scores for face and body categories. The server filters bounding boxes using a confidence threshold and a non-maximum suppression procedure and extracts rectangular sub-images corresponding to facial regions and body regions. The server resizes the extracted regions to a standardized size required by subsequent models.

The server performs expression analysis processing on the facial regions by executing an emotion classification neural network on the processor or the accelerator. The server loads a trained model whose architecture includes a stack of convolution layers, non-linear activation layers, pooling layers, and one or more fully connected layers. The model maps a facial image tensor to a probability vector over emotion classes such as fear, sadness, anger, happiness, and neutral. The server uses a softmax function in the final layer to normalize outputs and interprets the resulting probabilities as confidence measures. The server records, in a structured record, a facial region identifier, a timestamp, and the emotion probabilities.

The server performs posture estimation processing and motion recognition processing on the body regions. The server applies a keypoint detection model that estimates positions of human body joints such as head, shoulders, elbows, hips, knees, and ankles. The model architecture may include convolutional and deconvolutional layers that generate heatmaps for each joint type. The server identifies peak positions in the heatmaps and converts them to coordinate values in the image frame. The server then aggregates joint coordinates over a sequence of frames associated with a same subject track. The server constructs a time-series feature sequence representing joint positions, velocities, and relative distances between subjects.

The server performs motion recognition processing by feeding the time-series feature sequence into a temporal classification model. In one example, the model includes a recurrent neural network, such as a long short-term memory network, or a temporal convolutional network. The model receives as input a sequence of joint-based feature vectors and outputs, for each time interval, a distribution over action classes such as pushing, hitting, cornering, walking away, or neutral interaction. The server stores an action label, a confidence value, and an associated time range in a structured record.

The server combines the results of the expression analysis processing and the motion recognition processing to compute a risk index related to a possibility of bullying. The server aligns facial emotion results and action recognition results in time and in image coordinates. The server forms an interaction feature vector that includes, for each pair or group of subjects, aggregated statistics such as frequency of fear classification for a particular subject, number of aggressive actions directed toward that subject, duration of co-occurrence between aggressive actions and fearful expressions, and relative spatial positions of subjects. The server stores the interaction feature vector as input to a discrimination model.

The server executes the discrimination model to calculate the risk index. In one embodiment, the discrimination model is implemented as a gradient-boosted decision tree or a feedforward neural network trained to map interaction feature vectors to a numerical risk score between 0 and 1. The model is trained with a loss function, such as a cross-entropy loss or a mean squared error, that penalizes deviation between predicted risk scores and target labels derived from historical confirmed or rejected events. During inference, the server applies the discrimination model to current interaction feature vectors and obtains a risk index. The server compares the risk index to one or more thresholds to determine whether to trigger notification generation.

When the risk index exceeds a predetermined threshold, the server generates structured data describing a situation. The structured data comprises identifiers of involved subjects, time intervals of interest, location identifiers, aggregated emotion probabilities, counts and types of aggressive actions, and the computed risk index. The server then converts the structured data into a natural language prompt sentence. The server uses a template-based text generation module that maps fields of the structured data to phrases. For example, when the data indicates that one subject shows a high frequency of fearful expressions and has been pushed multiple times by the same group, the server generates a prompt sentence such as:

“The system has detected that one child frequently shows a fearful facial expression and has been pushed by the same group of three children three times within ten minutes in Classroom 2B. Please propose specific, practical steps that teachers and parents should take to support the child and prevent further bullying.”

In other cases, the server generates prompt sentences such as:

“A child's facial expressions are predominantly fearful when interacting with a specific group of classmates, and three pushing incidents have been detected in the last week. Provide detailed guidance for teachers and parents on how to intervene safely and effectively.”

or

“The system often detects that a child looks scared but finds no clear physical aggression. Propose preventive measures and conversational approaches that guardians and teachers can use to understand the situation and prevent potential bullying.”

The server supplies the prompt sentence to a generative AI model. The server may host the generative AI model locally or access it through an application programming interface. The generative AI model is implemented as a neural network architecture configured for sequence-to-sequence generation using an attention mechanism, such as a transformer architecture. The server tokenizes the prompt sentence, converts tokens into embedding vectors, and processes the embeddings through multiple layers of multi-head attention and feedforward networks. The decoder component of the generative AI model generates output tokens sequentially, conditioned on the encoded prompt representation. The server receives the generated token sequence and reconstructs a response sentence in natural language.

The server analyzes the response sentence to extract warning content and countermeasure content. The server may apply a rule-based parser or a secondary classification model to segment the response into an explicit warning message and a list of concrete countermeasures. The server then constructs notification information as a data structure that includes at least the warning message, the countermeasures, a summary of analysis results, and references to evidence frames or time intervals.

The server transmits the notification information to the terminal or to another user display device via the communication path. The server encapsulates the notification information in a structured message format. The terminal receives the notification information and displays it on a graphical user interface. The terminal shows the warning message, a human-readable description of the situation, the risk index, and the countermeasures. The terminal may also provide interactive elements that allow the user to open thumbnail images or video segments that correspond to detected events.

The user reviews the warning message and countermeasures and may input feedback information via the terminal. The user can specify whether the event corresponds to actual bullying, suspected bullying, or a false alarm. The user may also input textual comments describing contextual facts, misdetections, or additional details. The terminal transmits the feedback information to the server.

The server associates the feedback information with corresponding analysis results and stores them as training records in a database. Each training record includes the imaging information identifier, derived facial expression results, motion recognition results, interaction feature vectors, the risk index, the generated prompt sentence, the generative AI model response, the notification information, and the user feedback. The server periodically performs a learning process using these training records.

During the learning process, the server uses the records as training data to update parameters of the discrimination model. The server computes a loss function that measures a discrepancy between predicted risk indices and ground-truth labels derived from the feedback. The server performs an optimization algorithm such as stochastic gradient descent or a variant thereof to update model weights. The server may apply regularization techniques, such as dropout or weight decay, and data augmentation techniques such as random cropping or brightness adjustment on the imaging information for robustness. The server evaluates the updated model using an evaluation index, such as an area under a receiver operating characteristic curve or an F1 score, on a validation subset of records. If the evaluation index does not satisfy a predetermined criterion, the server may adjust the model configuration, such as number of layers or number of hidden units, or adjust thresholds used to trigger notifications.

The server can also update the process for generating the prompt sentence. By analyzing patterns in successful and unsuccessful interventions and user feedback on the usefulness of generated countermeasures, the server can adjust sentence templates, phrase ordering, or detail level of the prompt sentence. This adjustment is implemented as a modification of rules in the template-based generation module or as parameter tuning of an auxiliary language model that rewrites intermediate structured descriptions into final prompt sentences. As a result, the prompt sentences gradually become more informative and better suited to elicit effective responses from the generative AI model.

The described configuration improves computer technology in several ways. The server does not merely automate human judgment but executes a non-traditional sequence of machine-level operations that exploit multimodal, time-series feature integration. By computing interaction-level feature vectors that capture joint patterns of facial expressions and body motions across multiple subjects and across time, the server reduces noise and instability inherent in per-frame decision making. This integration reduces false alarms and enables more stable discrimination, which in turn reduces unnecessary communication of low-value alerts and lowers network load.

Furthermore, the server uses a generative AI model in a technically constrained manner by constructing prompt sentences from structured data instead of directly passing raw text. The structured-to-prompt conversion ensures that relevant features are compactly encoded, thereby reducing prompt length and the computational cost of generative inference. The feedback-driven updating of both discrimination and prompt-generation components forms a closed loop that improves model performance and computational efficiency over time. For example, as thresholds and model parameters are updated, the server can reduce the number of borderline alerts, thus lowering the number of generative AI calls and saving processing cycles.

The architecture also improves data management. By storing interaction feature vectors, risk indices, and user feedback in structured records, the server can perform efficient indexing, querying, and batch training. This structured approach allows the server to use optimized database queries and batch processing on the processor or accelerator, which increases throughput and decreases latency for both real-time detection and periodic retraining.

In another embodiment, the server implements alternative model architectures. For example, the server may use a graph neural network to represent interactions between subjects as nodes and edges with features derived from distance, relative motion, and co-occurrence of emotions. The graph neural network propagates messages along edges to compute node-level or graph-level bullying-risk scores. In another variation, the server may replace a recurrent motion recognition model with a transformer-based temporal model that uses self-attention over sequences of joint features.

In another embodiment, the terminal performs partial preprocessing such as face detection or pose estimation on-device before transmission, and sends only reduced feature representations to the server. This variation can further reduce bandwidth usage and protect privacy, while the server still performs the discrimination and prompt-generation processes. Because the terminal and server cooperatively partition the computation pipeline, processing load and communication costs can be balanced according to deployment constraints.

By linking acquisition, multimodal analysis, discrimination, generative prompt-based guidance, and feedback-driven learning into an integrated system, the terminal, server, and user collectively achieve technical effects that include improved detection accuracy, reduced false positive and false negative rates, reduced communication load through more selective alerting, improved computational efficiency in generative AI use, and enhanced stability of risk assessment over time. The described embodiments therefore provide a concrete application of computer technology to a real-world monitoring problem and demonstrate improvements at the level of data structures, model architectures, processing pipelines, and resource utilization, rather than merely automating a human mental process.

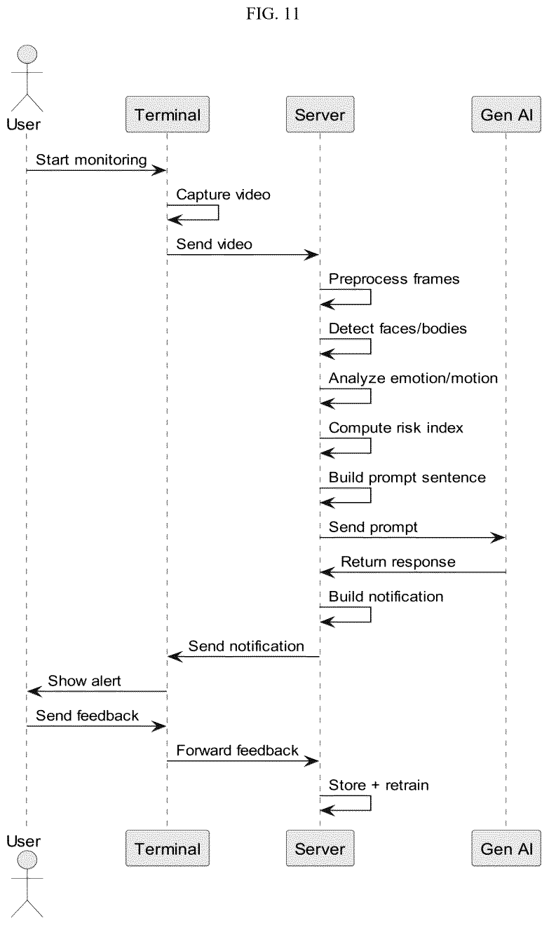

The following describes the processing flow using FIG. 11.

### Step 1

The terminal acquires imaging information. The terminal uses an image acquisition device such as a camera to capture a sequence of frames of a monitoring area. The input to the terminal is an analog or raw sensor signal representing the scene. The terminal controls the camera via an operating system interface, sets parameters such as resolution, frame rate, and exposure, and converts the raw sensor signal into digital image frames. The terminal encodes the frames into a compressed format, attaches metadata such as timestamps and device identifiers, and outputs imaging information as a stream of digital frames with associated metadata.

### Step 2

The terminal transmits the imaging information to the server. The input to the terminal is the encoded imaging information and metadata generated in Step 1. The terminal establishes a secure network connection using a communication protocol, segments the imaging information into data packets, and applies encryption. The terminal sends the packets over a wired or wireless network to the server and monitors transmission status. The output of the terminal is a series of encrypted data packets carrying imaging information and metadata addressed to the server.

### Step 3

The server receives and buffers the imaging information. The input to the server is the encrypted data packets transmitted by the terminal. The server terminates the secure connection, decrypts the packets, verifies integrity, and reconstructs the original imaging information and metadata. The server writes the reconstructed data into a buffer in main memory and optionally stores longer segments on a storage device. The output of the server is a sequence of decoded image frames and associated metadata prepared for analysis.

### Step 4

The server performs basic image preprocessing. The input to the server is the decoded image frames and metadata from Step 3. The server converts each frame into a standard color space, resizes the frame to a predetermined resolution, and normalizes pixel values using predefined mean and standard deviation parameters. The server may apply noise reduction or contrast enhancement. The server stores each processed frame as a numerical array in memory. The output of the server is a sequence of normalized image arrays suitable for further analysis.

### Step 5

The server detects facial regions and body regions. The input to the server is the normalized image arrays from Step 4. The server applies a detection model that computes feature maps over the image and predicts candidate bounding boxes for faces and bodies, with associated confidence scores. The server filters boxes by confidence thresholds, performs non-maximum suppression to remove overlaps, and assigns identifiers to each detected subject. The server crops the image arrays at the bounding boxes, resizes the crops to standard sizes, and records coordinates and identifiers. The output of the server is a set of cropped facial region arrays, cropped body region arrays, and detection metadata including locations and subject identifiers.

### Step 6

The server performs facial expression analysis processing. The input to the server is the cropped facial region arrays and detection metadata from Step 5. The server feeds each facial region array into an emotion classification neural network, which performs a series of matrix multiplications, non-linear activations, and pooling operations to compute high-level features. The network outputs a probability vector over emotion classes. The server associates each probability vector with the corresponding subject identifier and timestamp and calculates summary statistics such as maximum probability and dominant emotion. The output of the server is a set of emotion analysis records, each including a subject identifier, a timestamp, and emotion probabilities.

### Step 7

The server performs posture estimation processing. The input to the server is the cropped body region arrays and detection metadata from Step 5. The server executes a keypoint estimation model that generates heatmaps for multiple joint types. The server detects peaks in each heatmap, converts peak locations into joint coordinates in image space, and optionally refines positions using interpolation. The server links coordinates across consecutive frames for the same subject based on identifier matching. The output of the server is a time-series of joint coordinate sets for each subject, with timestamps and confidence values.

### Step 8

The server performs motion recognition processing. The input to the server is the time-series of joint coordinate sets from Step 7. The server converts joint coordinates into feature vectors that may include relative positions, velocities, accelerations, and distances between subjects. The server groups feature vectors into temporal windows and feeds each window into a motion recognition model. The model processes the sequence and outputs probabilities for action classes such as pushing, hitting, or neutral behavior. The server assigns an action label based on the highest probability, records the time range, and associates the label with subject identifiers. The output of the server is a set of motion recognition records containing action labels, confidence scores, subject identifiers, and time intervals.

### Step 9

The server constructs interaction feature vectors and calculates a risk index. The input to the server is the emotion analysis records from Step 6 and the motion recognition records from Step 8. The server aligns emotion and action records by timestamps and spatial proximity, groups records by potential victim and aggressor combinations, and computes aggregated features such as counts of aggressive actions, frequency and duration of fearful expressions, and co-occurrence statistics. The server concatenates these aggregated values into interaction feature vectors and feeds them into a discrimination model. The model computes a numerical risk score using its learned parameters. The server compares the risk score with one or more thresholds and determines a risk level. The output of the server is a risk index for each interaction and an associated risk level classification.

### Step 10

The server determines whether to generate notification information. The input to the server is the risk index and risk level classification from Step 9. The server evaluates the risk level against a predetermined criterion, such as whether the risk index exceeds a high-risk threshold. If the criterion is not met, the server records the analysis results without generating a notification. If the criterion is met, the server marks the event for notification generation and proceeds to prepare structured data. The output of the server is either a non-notified record or a flagged event record including structured analysis data for notification.

### Step 11

The server generates structured data describing a situation. The input to the server is the flagged event record from Step 10. The server collects identifiers of involved subjects, the location, the time interval, summary statistics of emotions and actions, and the risk index. The server arranges these data elements into a structured representation with predefined fields, such as victim identifier, aggressor group identifier, number of aggressive actions, percentage of fearful frames, and environment identifier. The output of the server is a structured situation data object that captures the essential parameters of the detected event.

### Step 12

The server constructs a natural language prompt sentence. The input to the server is the structured situation data object from Step 11. The server selects a template based on the type and severity of the event and maps fields of the structured data into template slots. The server generates a grammatically correct sentence or paragraph that describes the situation and explicitly requests guidance. For example, the server outputs a prompt sentence such as “The system has detected that one child frequently shows a fearful facial expression and has been pushed by the same group of three children three times within ten minutes in Classroom 2B. Please propose specific, practical steps that teachers and parents should take to support the child and prevent further bullying.” The output of the server is a prompt sentence in natural language that encodes the structured data.

### Step 13

The server queries a generative AI model and acquires a response sentence. The input to the server is the prompt sentence from Step 12. The server tokenizes the sentence into tokens, converts tokens into embeddings, and sends the embeddings or the raw text to the generative AI model. The generative AI model processes the input through its layers and generates output tokens representing a response. The server reconstructs the response as a text string, which typically includes warning language and recommended countermeasures. The output of the server is a response sentence or multiple sentences that describe how to handle the detected situation.

### Step 14

The server derives a warning message and concrete countermeasures from the response sentence. The input to the server is the response sentence from Step 13. The server analyzes the response text using pattern matching or a classification model to separate generic descriptions from actionable steps. The server designates a part of the text as a warning message and identifies specific recommended actions as countermeasures. The server then combines these elements with the structured analysis summary to form notification information. The output of the server is notification information containing a warning message, countermeasures, and a summary of the analysis.

### Step 15

The server transmits the notification information to the terminal. The input to the server is the notification information from Step 14. The server serializes the notification information into a message format and selects one or more target terminals based on recipient data. The server sends the message via the communication path using a secure protocol. The output of the server is one or more network messages that deliver the notification information to user display devices.

### Step 16

The terminal receives and displays the notification information. The input to the terminal is the network message containing the notification information from Step 15. The terminal parses the message, extracts the warning message, countermeasures, and summary, and updates its user interface. The terminal renders text in a display area, optionally with visual indicators of risk level and links to related frames or time intervals. The output of the terminal is a displayed alert screen that presents the notification to the user.

### Step 17

The user reviews the notification and provides feedback. The input to the user is the displayed alert screen from Step 16. The user reads the warning message and countermeasures and observes any associated images or time markers. The user then selects a feedback option such as “confirmed bullying,” “possible bullying,” or “false alarm,” and may input additional comments using a text field. The output of the user is feedback information entered through the terminal interface.

### Step 18

The terminal transmits the feedback information to the server. The input to the terminal is the feedback information created by the user in Step 17. The terminal packages the feedback into a structured message, associates it with the event identifier, and sends it via the communication path to the server using a secure protocol. The output of the terminal is a feedback message addressed to the server.

### Step 19

The server records analysis results and feedback as training data. The input to the server is the feedback message from Step 18 and the previously stored analysis records from Steps 6 to 14. The server links the feedback to the corresponding event via the event identifier and constructs a training record that includes emotion analysis results, motion recognition results, interaction feature vectors, risk index, prompt sentence, response sentence, notification information, and user feedback. The server stores the training record in a database for later learning. The output of the server is an updated training dataset containing labeled examples.

### Step 20

The server executes a learning process to update models and thresholds. The input to the server is the training dataset from Step 19 and current model parameters and thresholds. The server selects a batch of training records, extracts interaction feature vectors and corresponding labels, and computes a loss function for the discrimination model. The server updates the model weights using an optimization algorithm and evaluates performance using an evaluation index. If performance does not meet a criterion, the server adjusts model configuration or thresholds. The server may also modify rules or templates for prompt sentence generation based on correlations between feedback and notification outcomes. The output of the server is an updated discrimination model, updated thresholds, and optionally updated prompt generation rules that will be used in future executions of Steps 9 through 14.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented monitoring systems typically perform simple rule-based or threshold-based analysis directly on raw image streams or low-level sensor values. Such systems often rely on fixed heuristics applied to individual frames or short sequences and lack mechanisms to transform complex, time-varying visual information into a form that is suitable for higher-level, context-aware reasoning. As a result, these systems suffer from low detection accuracy for nuanced social situations, such as bullying among children, and tend to either miss important events or generate excessive false alarms.

Furthermore, existing architectures generally do not separate low-level perception processing from higher-level evaluative reasoning. They do not exploit generative AI models using structured, temporally aggregated intermediate representations. Instead, they attempt to either apply a discriminative model end-to-end to raw images or to directly feed unstructured or insufficiently processed data into a generative model. Such approaches lead to inefficient use of computational resources, suboptimal utilization of generative AI capabilities, and difficulty in adapting system behavior as data and operational conditions evolve.

In addition, many computer systems lack a closed feedback loop that connects user evaluation of alerts back into the core decision-making pipeline. Feedback from guardians, educators, or other stakeholders regarding the appropriateness of system-generated warnings is often stored only as auxiliary log data, if at all, and is not systematically used to recalibrate thresholds or retrain underlying models. This results in systems whose detection performance degrades or remains static over time as real-world conditions change, rather than progressively improving based on accumulated operational experience.

Accordingly, there is a need for an improved computer-implemented system and server-side processing architecture that: (i) transforms time-series image information from portable information processing apparatuses into structured, time-windowed feature information capturing emotional and motion states; (ii) uses this structured information to generate targeted prompt sentences for a generative AI model, thereby enabling more accurate, context-aware evaluation of complex social situations; (iii) automatically generates and delivers warning information when computed risk exceeds adaptive thresholds; and (iv) incorporates user evaluation information into a performance evaluation and retraining loop to continuously refine both discrimination models and generative-model-based decision logic. Such a system would provide a technical improvement in how computers process, represent, and evaluate image-based behavioral data, improving detection accuracy, reducing false positives and false negatives, and enabling adaptive, data-driven optimization of the overall monitoring pipeline.

The specific processing by the specific processing unit 290 of the data processing device 12 in Application Example 1 is realized by the following means.

The present invention provides a server comprising a processor configured to receive time-series image information from one or more portable information processing apparatuses, to extract person regions from the time-series image information, to calculate feature information indicative of emotional states and motion states for detected person regions, to aggregate the feature information over predetermined time windows to generate structured information, to generate in a natural language a prompt sentence for a generative AI model based on the structured information, to input the prompt sentence to the generative AI model and obtain evaluation information and explanation information regarding a possibility of bullying, to determine whether the evaluation information satisfies a threshold condition, to generate warning information including at least a detection time, identification information, and the explanation information when the threshold condition is satisfied, to transmit the warning information as notification information to a corresponding portable information processing apparatus, and to store the evaluation information and the warning information in association with a recording medium together with user evaluation information indicating appropriateness or inappropriateness of the warning information, and to periodically perform performance evaluation and model updating or threshold adjustment based on the stored information. This enables a computer system to convert raw time-series image data into temporally aggregated, semantically rich representations optimized for generative-model prompting, to leverage generative AI for higher-level contextual evaluation of bullying risk, to automatically and selectively issue warnings based on adaptive, data-driven thresholds, and to implement a closed feedback loop in which user evaluations are systematically utilized to refine discrimination models and generative-model decision criteria, thereby improving detection accuracy, computational efficiency, and robustness of the monitoring functionality over time.

The term “processor” refers to a hardware or virtual computation unit, such as a central processing unit, graphics processing unit, or dedicated processing circuitry, that executes instructions to perform data reception, analysis, generation, storage, and transmission operations as described in the claims.

The term “time-series image information” refers to a sequence of image data items, such as video frames or still images associated with time information, that represent changes in a scene over time.

The term “portable information processing apparatus” refers to an electronic device capable of data processing and communication, such as a handheld terminal, smartphone, tablet, or other mobile computing device, that can capture and transmit time-series image information.

The term “person region” refers to a spatial region within an image or frame that corresponds to at least a part of a human subject, such as a face or body, detected by image analysis or pattern recognition processing.

The term “feature information” refers to numerical or symbolic values derived from image data that characterize specific properties, such as emotional state features, motion state features, or other behavioral indicators associated with a person region.

The term “emotional state” refers to a state indicative of a person's affect or feeling, such as fear, sadness, anger, joy, or neutrality, inferred from facial expressions, posture, or other visual cues.

The term “motion state” refers to a state indicative of a person's physical movement or action, such as pushing, hitting, withdrawing, approaching, or other body motions, inferred from changes in position or posture over time.

The term “predetermined time window” refers to a defined interval of time, such as several seconds or minutes, over which feature information is collected and aggregated to form a summarized representation.

The term “structured information” refers to data that is organized in a predefined format, such as records, tables, or hierarchical objects, including identifiers, timestamps, feature values, and confidence scores, which are suitable for programmatic processing.

The term “prompt sentence” refers to a text string expressed in a natural language that is formulated to instruct or query a generative AI model to perform a particular analysis or evaluation based on provided information.

The term “generative AI model” refers to a computational model, such as a machine learning or neural network model, configured to generate textual or other content in response to input data, including large language models used to analyze structured information and produce evaluation and explanation information.

The term “evaluation information” refers to data output by the generative AI model or other analysis processes that represent an assessment of a condition, such as a probability, risk level, or classification indicating a possibility of bullying.

The term “explanation information” refers to information describing the reasoning, basis, or factors underlying an evaluation, such as textual descriptions of behavioral cues or conditions that led to a particular risk assessment.

The term “possibility of bullying” refers to a likelihood or risk that a person is subject to adverse or aggressive behavior, psychological pressure, or harassment by others, inferred from emotional and motion patterns.

The term “threshold condition” refers to one or more predetermined criteria, such as a numerical threshold, classification label, or rule set, used to determine whether the evaluation information warrants generation of warning information.

The term “warning information” refers to information indicating that the evaluation information has satisfied the threshold condition and that a potentially problematic situation, such as bullying, may be occurring or have occurred.

The term “detection time” refers to temporal information indicating when the system determined that the threshold condition was satisfied or that a particular event of interest was detected.

The term “identification information” refers to information enabling association with a subject or context, such as a device identifier, user identifier, location identifier, or event identifier.

The term “notification information” refers to information transmitted to a portable information processing apparatus or other terminal to inform a user of warning information, including messages, alerts, or prompts.

The term “recording medium” refers to any physical or virtual storage resource, such as semiconductor memory, magnetic storage, optical storage, or a database, used to store evaluation information, warning information, user evaluation information, or time-series image information.

The term “information display screen” refers to a graphical user interface or display view presented on a portable information processing apparatus or other terminal, configured to present contents of notification information and related data to a user.

The term “user evaluation information” refers to information input by a user, such as an appropriateness judgment or feedback regarding warning information, indicating whether the warning was correct, incorrect, or uncertain.

The term “discrimination model” refers to a predictive model, such as a classifier or detector, configured to calculate feature information or perform recognition tasks based on input image data, including emotion recognition or motion recognition models.

The term “performance evaluation” refers to analysis of how accurately or effectively a model or system component operates, including computation of accuracy, error rates, or other metrics using stored data and user evaluation information.

The term “learning process” refers to a procedure for adjusting parameters of a model, such as training or fine-tuning a machine learning model, using data to improve its performance.

The term “threshold adjustment process” refers to a procedure for modifying one or more threshold conditions, such as raising or lowering numerical limits or altering decision rules, based on performance evaluation results.

The term “portable information processing apparatus corresponding to the warning information” refers to a portable device associated with, or designated to receive, particular warning information, for example based on an identifier or registration relationship between the device and a monitored subject.

In one embodiment, a server cooperates with one or more terminals to implement the claimed system. The server includes at least one hardware processor, a main memory, a nonvolatile storage device, and a network interface. The terminal includes a camera, a display unit, a user input unit, a memory, and a communication module. The server and the terminal are interconnected via a communication network such as a wireless local area network or a mobile communication network.

The terminal acquires time-series image information using the camera. The terminal uses an operating system level multimedia framework, such as a camera application programming interface, to convert optical images from the camera sensor into digital video frames. The terminal encodes the frames using a video codec, such as a block-based compression scheme, to reduce the data size. The terminal stores the encoded frames temporarily in a memory buffer and associates the frames with time information and device identification information. The terminal transmits the time-series image information to the server using a secure communication protocol, such as a transport layer security-based hypertext transfer protocol, thereby supplying the server with input data for analysis.

The server receives the time-series image information through the network interface and stores the received data in a buffer of the main memory or in a temporary area of the nonvolatile storage device. The server uses a multimedia processing library, such as a software toolkit for handling compressed video, to decode the encoded streams into raw image frames. The server thereby converts compressed, bandwidth-efficient data into spatially and temporally coherent pixel arrays suitable for subsequent analysis. By performing the decoding on the server, rather than on each terminal, the system centralizes computation, enabling more complex algorithms without overloading the portable device.

The server applies image recognition processing to the decoded frames. The server uses a computer vision library, such as a matrix-based image processing toolkit, to perform pre-processing operations including resizing, color-space conversion, and normalization. The server then applies a person detector implemented as a convolutional neural network. In one example, the server uses a multi-layer convolutional network with feature extraction layers, non-linear activation functions, pooling layers, and fully connected layers to estimate bounding regions corresponding to persons in the image. The server treats each bounding region as a person region and extracts the region as a separate cropped image. By restricting subsequent processing to the person regions, the server reduces the number of pixels that need to be processed, thereby increasing computational efficiency and reducing memory bandwidth.

The server computes feature information for each person region. The server, in one embodiment, executes an emotion recognition neural network that receives the cropped image as input. The server may implement the emotion recognition network as a deep convolutional neural network with multiple convolutional layers, batch normalization layers, pooling layers, and a final classification layer producing a probability distribution over discrete emotional categories. The server calculates an emotional state feature vector that encodes probabilities for categories such as fear, sadness, anger, joy, and neutral. In addition, the server implements a motion recognition model that processes sequences of person regions over time. In one example, the server uses a three-dimensional convolutional neural network or a combination of a convolutional network and a recurrent network, such as a long short-term memory network, to derive motion state features indicating actions such as pushing, hitting, withdrawing, approaching, or raising arms defensively. The server stores the emotional state and motion state feature vectors for each person region over time, along with corresponding time information.

The server aggregates the feature information over predetermined time windows. In one embodiment, the server defines a sliding time window, such as a ten-second interval, and groups all feature vectors belonging to each person within that interval. The server computes statistical summaries, such as average emotion probabilities, counts of aggressive motion detections, and durations of fearful or withdrawn states. The server organizes the aggregated results into structured information, for example, records containing a subject identifier, a start time and end time of the window, aggregated emotional features, aggregated motion features, and confidence values. This transformation from raw frame-level features to time-windowed structured information reduces data volume and emphasizes temporal patterns that are difficult to capture with frame-based processing alone.

The server generates a prompt sentence in a natural language based on the structured information. The server converts the structured information into a textual description that is optimized for a generative AI model. In one example, the server constructs a prompt sentence such as:

“Based on the following description of children's facial expressions and body movements over the last 10 seconds, determine whether there is a possibility that any child is being bullied and explain your reasoning. Child A: fearful expression with 0.85 confidence, body leaning backward, being approached rapidly by Child B. Child B: angry expression with 0.80 confidence, repeated pushing motion toward Child A.”

In another example, the server constructs a prompt sentence such as:

“Using the following analysis of emotional states and motion patterns, assess the likelihood of bullying and classify the risk as low, medium, or high, and explain which behavioral indicators support your conclusion.”

The server uses a text-generation interface to pass the prompt sentence to a generative AI model. The server, in one embodiment, hosts a large language model on the server machine. The generative AI model may use a transformer architecture including multi-head self-attention layers, feed-forward layers, positional encoding, and layer normalization. The server stores the model parameters, such as weight matrices, in the main memory or on a high-speed storage device and loads them into processing units, such as graphics processors, for efficient execution. The server inputs the prompt sentence token sequence into the generative AI model, which performs sequential attention-based computations to generate evaluation information and explanation information. The server thereby uses the generative AI model not as a black-box oracle, but as a specialized reasoning engine that operates on carefully structured and temporally aggregated features, which constitutes a nonconventional use pattern and leads to improved interpretability and accuracy.

The server parses the generated text and converts the text into machine-readable evaluation information. The server uses pattern matching or a secondary classification procedure to extract a risk score, such as a real-valued score between zero and one, and a risk label such as low, medium, or high. The server also extracts explanation information, such as sentences identifying which emotional and motion states contributed to the assessment. The server stores the evaluation information together with the structured information and the original time-series image information in the recording medium. This data organization provides a traceable linkage from raw input to high-level decision, enabling auditability and further algorithmic refinement.

The server compares the evaluation information with one or more threshold conditions. The server may store threshold values in a configuration database and retrieves the values at runtime. For example, the server may treat a risk score greater than a set value as satisfying the threshold condition. If the threshold condition is satisfied, the server composes warning information. The warning information includes a detection time, identification information such as a subject identifier or device identifier, a risk label, and a condensed explanation. The server formats the warning information as notification information suitable for push notification services or other messaging systems.

The terminal receives the notification information through its communication module. The terminal invokes the operating system notification framework to display a visual alert on the display unit. The terminal shows a summary of the warning information, such as a text stating that there is a high possibility of bullying related to a particular subject at a specific time. The terminal allows the user to tap or select the notification to open a dedicated application screen.

The user operates the terminal to view detailed information. The terminal requests, from the server, additional data associated with the warning, such as the explanation information and the relevant time interval of the time-series image information. The server sends a response containing the requested records. The terminal renders a detailed information display on the screen, showing an explanation text and, in some embodiments, a low-resolution video segment. The user can understand the basis of the detected risk, as the explanation information directly references emotional and motion features.

The user can provide user evaluation information through the terminal. The terminal displays user interface elements, such as buttons or selectable options, allowing the user to classify the warning as appropriate, inappropriate, or uncertain. The terminal sends the user evaluation information to the server, associated with the corresponding evaluation information and time window. The server stores the user evaluation information in the recording medium as training and feedback data.

The server executes a performance evaluation process based on the stored user evaluation information and the stored time-series image information. The server identifies, for example, instances where high-risk warnings were labeled inappropriate or where low-risk evaluations preceded later-confirmed incidents. The server computes performance metrics such as precision, recall, and false alarm rate. The server, in one embodiment, updates the parameters of the discrimination models, such as the emotion recognition and motion recognition neural networks, using a supervised learning algorithm. The server defines a loss function, such as a cross-entropy loss over labels indicating the correctness of previous predictions, and applies gradient-based optimization using backpropagation to adjust the network weights. The server may use data augmentation techniques, such as random cropping, rotation, or brightness adjustment, to increase the robustness of the models during retraining. By performing this training on the server with centralized data, the system can improve model accuracy without requiring software changes on the terminals.

The server also adjusts the threshold conditions. The server, for example, uses the performance metrics to determine if the threshold for generating warnings should be raised or lowered. If the false positive rate is too high, the server increases the threshold value to require a higher risk score before generating a warning. Conversely, if critical events are missed, the server lowers the threshold. The server can implement an optimization algorithm that searches for threshold values that maximize a combined objective, such as maximizing detection rate while constraining the false positive rate. The server stores the updated thresholds and applies them in subsequent evaluations, thereby closing the feedback loop.

This architecture provides several technical effects. The server transforms complex, high-dimensional video data into compact, time-windowed feature representations, reducing storage and transmission requirements while emphasizing temporal context relevant to bullying detection. The server offloads computationally intensive tasks, such as convolutional and recurrent neural network inference, from the terminal to a centralized hardware platform optimized for parallel processing, thereby improving processing speed and thermal efficiency of the overall system. The server uses a generative AI model in a nonconventional manner by constructing prompt sentences from structured, temporally aggregated feature information rather than raw text or raw images, which improves the model's reasoning accuracy and reduces spurious responses. The feedback mechanism that links user evaluation information to model retraining and threshold adjustment enables the system to reduce error rates over time and adapt to changing behavioral patterns in real environments.

Alternative embodiments are possible. In one embodiment, the server uses a different architecture for the motion recognition model, such as a graph-based neural network that treats body keypoints as vertices and learns motion patterns as graph signals. In another embodiment, the server implements the generative AI model as an encoder-decoder network trained specifically for risk explanation generation, with an encoder receiving numeric features and a decoder generating natural language explanation information. In yet another embodiment, a portion of the feature extraction processing is executed on the terminal, such that the terminal transmits intermediate feature information instead of raw video frames, thereby reducing communication load at the expense of increased computation on the portable device. In all such embodiments, the core concept remains that the server or the terminal systematically converts time-series image information into structured feature information, uses a generative AI model according to a specifically designed prompt sentence scheme, and employs an iterative performance evaluation and update loop to improve the technical performance of the monitoring system.

Through these configurations, the system does more than automate a human evaluation process. The server implements specific data structures, model architectures, and threshold adjustment algorithms that are tailored to the constraints of time-series image processing and networked terminals. The server improves the way computers store, represent, and evaluate behavioral data, enhances detection accuracy and computational efficiency, and reduces network and storage overhead, thereby constituting an improvement to computer technology itself.

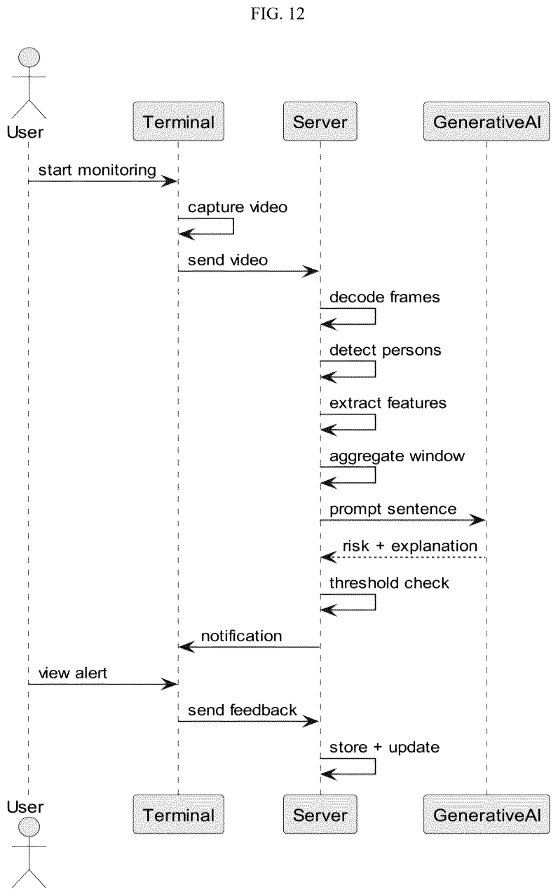

The following describes the processing flow using FIG. 12.

### Step 1

The terminal captures time-series image information. The terminal uses its camera to acquire a continuous sequence of frames of a scene including one or more children. As input, the terminal receives analog optical signals from the image sensor. The terminal converts these signals into digital image frames, encodes them using a video codec, and associates each frame with a timestamp and device identifier. As output, the terminal produces a compressed video stream with metadata stored in a memory buffer.

### Step 2

The terminal transmits the time-series image information to the server. As input, the terminal uses the buffered compressed video stream and associated metadata. The terminal segments the stream into network packets, wraps the packets in a secure communication protocol, and sends them via a wireless interface to a designated server address. As output, the terminal provides the server with an incoming data stream containing time-aligned compressed video and identification information.

### Step 3

The server receives and decodes the time-series image information. As input, the server obtains the compressed video packets from the network interface. The server reassembles the packets into a continuous bitstream, stores the stream in memory, and invokes a multimedia decoding library to convert the compressed data into raw image frames represented as pixel arrays. As output, the server generates a sequence of decoded frames with corresponding timestamps and device identifiers ready for image analysis.

### Step 4

The server detects person regions within the decoded frames. As input, the server uses the raw image frames with timestamps. The server applies image pre-processing, such as resizing and color conversion, and then runs a person detection model to locate bounding boxes surrounding people in each frame. The server calculates bounding box coordinates and confidence scores, and crops the relevant regions from the original frames. As output, the server produces a set of cropped person images per frame, each associated with a person region identifier and time information.

### Step 5

The server computes emotional state features for each person region. As input, the server uses the cropped person images and their timestamps. The server feeds each cropped image into an emotion recognition neural network, which performs convolution and classification operations to estimate probabilities of emotional categories. The server generates an emotional feature vector for each image, including category probabilities and an overall confidence value. As output, the server yields time-stamped emotional state features linked to each person region.

### Step 6

The server computes motion state features for sequences of person regions. As input, the server uses ordered sequences of cropped person images over a time interval for each person region. The server feeds these sequences into a motion recognition model, which analyzes temporal changes in position and posture to classify motion types. The server calculates motion labels such as pushing or withdrawing and assigns confidence values to each label. As output, the server produces time-stamped motion state features for each person region.

### Step 7

The server aggregates emotional and motion features over a predetermined time window. As input, the server uses lists of emotional and motion features with timestamps for each person region. The server groups the features into fixed time windows, such as ten-second intervals, and computes summary statistics including average probabilities, maximum intensities, and counts of specific motion types. The server organizes these summaries into structured records containing subject identifiers, time intervals, aggregated emotional metrics, and aggregated motion metrics. As output, the server generates structured information representing behavioral patterns for each time window.

### Step 8

The server generates a prompt sentence for a generative AI model based on the structured information. As input, the server uses the structured records for one or more subjects in a given time window. The server converts numerical and categorical values into a natural-language description and inserts the description into a prompt template. The server, for example, concatenates text segments describing emotions, motions, and time intervals into a coherent instruction. As output, the server produces a prompt sentence that describes the observed behavior and requests an assessment of bullying risk.

### Step 9

The server queries the generative AI model with the prompt sentence. As input, the server uses the generated prompt sentence as text. The server tokenizes the prompt, sends the token sequence to the generative AI model through a model interface, and initiates inference. The generative AI model processes the tokens to generate a response text containing a risk assessment and an explanation. As output, the server receives a natural-language response that includes evaluation information, such as a risk classification or score, and explanation information describing the reasoning.

### Step 10

The server extracts structured evaluation information from the generative AI model response. As input, the server uses the response text produced by the generative AI model. The server applies parsing logic or secondary classifiers to identify key elements, such as a bullying risk level, a numerical risk score, and textual explanation segments. The server maps these elements into a structured format with defined fields. As output, the server generates a standardized evaluation record containing risk indicators and explanation information associated with the original time window.

### Step 11

The server determines whether a threshold condition for warning generation is satisfied. As input, the server uses the structured evaluation record and preconfigured threshold conditions stored in a configuration repository. The server compares the risk score or risk label from the evaluation record with the threshold values, and may also consider contextual parameters, such as recent alert frequency. If the comparison indicates that the risk exceeds the threshold, the server sets a trigger flag. As output, the server produces a decision result indicating whether to create warning information.

### Step 12

The server generates warning information and notification information when the threshold is satisfied. As input, the server uses the decision result, the evaluation record, the structured information, and identification information such as subject or device identifiers. The server composes warning information including a detection time, identification information, a risk label, and a concise explanation text. The server encapsulates the warning information into a notification format compatible with terminal applications or messaging services. As output, the server produces one or more notification messages ready for transmission to terminals.

### Step 13

The server transmits notification information to the terminal. As input, the server uses the prepared notification messages and a list of destination terminals associated with the relevant subject or device. The server sends the messages through a push notification service or direct network communication, applying the appropriate routing and addressing. As output, the server delivers notifications to the terminals that are configured to receive alerts for the corresponding subjects.

### Step 14

The terminal displays the notification and detailed information to the user. As input, the terminal receives the notification message from the server. The terminal passes the message contents to the operating system notification subsystem and renders a visible alert containing a summary of the warning information. When the user opens the alert, the terminal requests additional detail from the server and displays an information screen showing the explanation text, risk level, and time interval. As output, the terminal provides the user with a graphical presentation of the system's assessment and its basis.

### Step 15

The user provides feedback as user evaluation information. As input, the user observes the displayed information on the terminal and interacts with user interface elements, such as buttons or toggles, to indicate whether the warning is appropriate or inappropriate. The terminal captures this input event and transforms it into user evaluation information with an associated label and timestamp. As output, the terminal produces a feedback record ready to be sent to the server.

### Step 16

The terminal transmits the user evaluation information to the server. As input, the terminal uses the feedback record generated from the user's interaction. The terminal packages the record with identifiers linking it to the original evaluation and warning information, and sends it over the network to the server using a secure protocol. As output, the terminal supplies the server with labeled feedback data related to prior warnings.

### Step 17

The server stores the evaluation information, warning information, and user evaluation information in a recording medium. As input, the server receives the user evaluation information and accesses the corresponding evaluation and warning records. The server writes these combined data items into a structured database, associating them by identifiers and timestamps. The server may index the records by subject, time, and risk level to support efficient retrieval. As output, the server maintains an organized history of system decisions and user feedback for later analysis and model updating.

### Step 18

The server performs performance evaluation and model or threshold updating. As input, the server uses stored evaluation records, warning records, and user evaluation information from the recording medium. The server calculates performance metrics by comparing predicted risk indicators with user feedback labels, identifies patterns of false positives and false negatives, and determines adjustments to model parameters or threshold values. The server may initiate a retraining process for the discrimination models using stored data and adjust configuration settings for risk thresholds. As output, the server produces updated models and updated threshold conditions that are used in subsequent iterations of Steps 4 through 12.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented monitoring systems that process image information and acoustic information in educational environments typically rely on fixed rule sets or simple classification models. Such systems often treat video analysis, audio analysis, and notification logic as separate, loosely coupled modules. As a result, these systems suffer from several technical limitations in terms of information processing efficiency, robustness, and adaptability.

First, conventional systems generally process image streams and audio streams independently without generating integrated event information that consistently associates expression states, body motion states, and conversation information with precise time information and position information. This fragmented processing leads to incomplete context, inconsistent feature representation, and inefficient correlation between heterogeneous data types. Accordingly, the processor cannot reliably distinguish between normal interactions and high-risk interactions, which causes unstable detection accuracy, excessive false positives, and missed detections.

Second, conventional systems often embed static decision thresholds and hand-crafted rules for assessing a possibility of bullying. These static configurations do not adapt to changing behavioral patterns or environmental conditions and require manual tuning by human operators. As the volume and complexity of monitored data increase, the burden on system administrators also increases, and the underlying computer resources are not effectively utilized to refine evaluation logic or improve model behavior.

Third, existing notification mechanisms generally use template-based messages that are generated from a small set of pre-defined patterns. This approach does not exploit advanced natural language processing capabilities to generate notification messages and behavioral guidelines that are context-sensitive and tailored to specific integrated event information. Consequently, guardians and educational workers receive low-granularity, generic alerts that do not fully convey the underlying analysis results or provide clear, actionable guidance, thereby reducing the practical utility of the system.

Fourth, conventional systems lack a structured feedback loop that uses post-response information and feedback information from guardians and educational workers to automatically refine the way in which the processor constructs prompts for a generative information processing model and to adjust determination conditions and thresholds. Without such a feedback-driven updating mechanism, the system cannot systematically improve the quality of prompt sentences, the stability of evaluation values, or the overall usefulness of generated notification messages over time.

Therefore, there is a technical need to improve computer-implemented monitoring and analysis in educational environments by providing: (i) a unified processing pipeline that converts multimodal data into integrated event information; (ii) a mechanism that uses a generative information processing model via structured prompt sentences to compute evaluation values for the possibility of bullying and generate context-aware notification messages; and (iii) a learning control mechanism that updates prompt configuration and evaluation parameters based on real-world feedback, thereby improving detection accuracy, robustness, and the utility of notifications in a manner rooted in concrete improvements to computer technology.

The specific processing by the specific processing unit 290 of the data processing device 12 in Example 2 is realized by the following means.

The present invention provides a server comprising a processor configured to acquire image information and acoustic information of a child from a biological information acquisition device, record the image information and the acoustic information in association with time information and position information, analyze the image information by using image analysis technology to detect a face region, extract an expression state and a body motion state, and convert the expression state and the body motion state into structured data as behavior information aggregated on a time basis, analyze the acoustic information by using speech analysis technology to convert a speech content into character information, calculate an emotion state and an aggressiveness index, and convert the emotion state and the aggressiveness index into structured data as conversation information aggregated on a time basis, associate the expression state, the body motion state, and the conversation information with the time information and the position information to generate integrated event information indicating an interaction event between children for each predetermined time interval, convert the integrated event information into a description text in natural language, generate a prompt sentence including the description text, input the prompt sentence into a generative information processing model, obtain an evaluation value indicating a possibility of bullying and an explanation of a reason for the evaluation value, classify the integrated event information into a risk level based on the evaluation value, input, into the generative information processing model, a prompt sentence including the risk level and the integrated event information, cause the generative information processing model to generate, in natural language, a notification message including a warning text and behavioral guidelines according to a state of the child, a detected behavior, and a conversation content, and transmit the notification message to an information processing terminal of a guardian and an educational worker while generating an information presentation screen that enables a chronological list display of the integrated event information, the evaluation value, the risk level, and the notification message and recording, in association with each other, the evaluation value, the risk level, and post-response information and feedback information acquired from the guardian and the educational worker so as to automatically update components and an expression format of the prompt sentence and adjust a determination condition and a threshold used for calculation of the evaluation value. This enables the server to implement an integrated, feedback-driven information processing pipeline that improves the technical performance of multimodal event detection by stabilizing correlation between image information and acoustic information, enhancing the accuracy and adaptability of automated bullying-risk evaluation, and generating context-aware notification messages and behavioral guidelines that make more effective use of computing resources through dynamic optimization of prompt construction and evaluation parameters.

The term “processor” refers to a hardware or virtual computation unit, such as a central processing unit or an execution core in a computing device, that is configured to execute instructions to perform data acquisition, analysis, generation, and control operations described in the present specification.

The term “biological information acquisition device” refers to any sensing apparatus, including but not limited to an imaging device or an acoustic sensing device, that is configured to capture physical phenomena related to a child, such as visual information of appearance and movement or sound information of speech and ambient noise.

The term “image information” refers to digital data representing visual scenes, including still images or sequences of frames, obtained from an imaging device and suitable for processing by image analysis technology.

The term “acoustic information” refers to digital data representing sound, including voice, background noise, and other audible events, obtained from an acoustic sensing device and suitable for processing by speech analysis technology.

The term “time information” refers to data indicating a temporal position of an event, such as a timestamp or a time interval, that can be used to synchronize or correlate multiple data streams.

The term “position information” refers to data indicating a spatial position or region in which an event occurs, such as a location within a facility or an identifier of a monitored area, that can be associated with acquired image information and acoustic information.

The term “image analysis technology” refers to a collection of algorithms and software components that process image information to detect, segment, classify, or track objects or regions of interest, including but not limited to face detection, body motion analysis, and feature extraction.

The term “face region” refers to an area within image information that corresponds to a human face or a part thereof, which can be detected and extracted by image analysis technology for further processing.

The term “expression state” refers to information indicating an emotional or affective condition inferred from the appearance of a face region, such as happiness, anger, fear, neutrality, or other recognizable facial expressions.

The term “body motion state” refers to information describing movement or posture of a human body, such as standing, approaching, pushing, or withdrawing, inferred from analysis of image information including body regions or pose keypoints.

The term “structured data” refers to information that is organized in a predefined data model, such as a record, a table, or a hierarchical format, in which specific fields represent attributes of behavior information or conversation information in a machine-processable manner.

The term “behavior information” refers to structured data representing one or more body motion states, expression states, or other physical actions of a child, aggregated over a predetermined time unit.

The term “speech analysis technology” refers to a collection of algorithms and software components that process acoustic information to recognize, transcribe, or interpret speech, including but not limited to speech-to-text conversion, prosody analysis, and speaker-independent recognition.

The term “character information” refers to textual data obtained by converting acoustic information representing speech content into a sequence of characters or tokens that can be further processed as text.

The term “emotion state” refers to information indicating an emotional characteristic of speech, such as calmness, anger, sadness, or excitement, inferred from acoustic features or transcribed text.

The term “aggressiveness index” refers to a numerical or categorical value that quantifies a degree of hostility, abusiveness, or threatening attitude inferred from character information or acoustic features.

The term “conversation information” refers to structured data representing transcribed speech content, emotion states, aggressiveness indices, or other linguistic and paralinguistic attributes, aggregated over a predetermined time unit.

The term “integrated event information” refers to data generated by associating behavior information and conversation information with corresponding time information and position information, to represent an interaction event among one or more children within a predetermined time interval.

The term “interaction event” refers to a set of temporally and spatially related behaviors and conversations involving at least one child, which are treated as a single analytical unit for evaluation of social or behavioral context.

The term “description text” refers to a representation of integrated event information expressed in natural language sentences, suitable for inclusion in a prompt sentence.

The term “natural language” refers to a human language expressed as text, such as English or another spoken language, as opposed to a programming language or a formal markup language.

The term “prompt sentence” refers to a natural language or semi-structured text input that describes integrated event information, risk levels, or other contextual data, and is supplied to a generative information processing model to cause the model to generate an output.

The term “generative information processing model” refers to a trained computational model, such as a neural network-based language model, that is configured to receive a prompt sentence and generate corresponding natural language output or other data as a function of the prompt sentence.

The term “evaluation value” refers to a numerical or categorical output produced by analysis using the generative information processing model or related processing, indicating a likelihood or degree of a specified condition, such as a possibility of bullying.

The term “possibility of bullying” refers to a probability or likelihood that a given interaction event corresponds to behavior that may be classified as bullying or harassment, as inferred from integrated event information.

The term “risk level” refers to a classification label or category, derived from an evaluation value, that indicates a severity or urgency of a particular interaction event with respect to the possibility of bullying.

The term “notification message” refers to natural language output that includes at least a warning text and behavioral guidelines, which is generated by the generative information processing model or by related processing and is intended to be transmitted to an information processing terminal.

The term “warning text” refers to a portion of a notification message that informs a recipient of a detected or suspected high-risk interaction event and its associated risk level.

The term “behavioral guidelines” refers to advice, recommendations, or instructions expressed in natural language, included in a notification message, and intended to guide actions of a guardian or an educational worker in response to an interaction event.

The term “information processing terminal” refers to any computing device, such as a smartphone, a tablet, or a personal computer, capable of receiving a notification message from the server and presenting the warning text and behavioral guidelines to a user.

The term “guardian” refers to a person who bears legal or practical responsibility for the care and supervision of a child, including a parent, a custodian, or another responsible adult.

The term “educational worker” refers to a person engaged in instruction, supervision, or support of children in an educational environment, such as a teacher, a counselor, or staff member.

The term “information presentation screen” refers to a graphical user interface screen generated by the processor that displays, in a chronological or otherwise organized manner, integrated event information, evaluation values, risk levels, and notification messages.

The term “threshold” refers to a reference value or set of reference values used by the processor for classification or decision-making, such as determining whether an evaluation value indicates a high risk level.

The term “notification condition” refers to criteria or rules that define when and to whom a notification message is to be transmitted, based on factors including evaluation values, risk levels, time periods, or locations.

The term “post-response information” refers to data representing actions taken or outcomes observed by a guardian or an educational worker after receiving a notification message, such as intervention steps or follow-up observations.

The term “feedback information” refers to data provided by a guardian or an educational worker that indicates a subjective or objective assessment of the accuracy, usefulness, or appropriateness of an evaluation value, a risk level, or a notification message.

The term “components of the prompt sentence” refers to constituent parts of a prompt sentence, such as sections describing time information, position information, behavior information, conversation information, and previously assigned risk levels.

The term “expression format of the prompt sentence” refers to the linguistic structure, wording, ordering, and style used to represent information in a prompt sentence supplied to the generative information processing model.

The term “determination condition” refers to a set of rules, parameters, or criteria used by the processor to interpret evaluation values or other analytical outputs and to determine classifications such as risk levels.

The term “learning control processing” refers to processing performed by the processor to adjust one or more parameters, conditions, or formats of prompt sentences and evaluation logic, based on historical records including post-response information and feedback information, so as to improve detection accuracy and the usefulness of notification messages over time.

In one embodiment, a user generates a bullying-detection program and deploys the program on a server and one or more terminals that are installed in an educational facility. The user installs the program on a general-purpose computing platform that includes a central processing unit, a memory, a storage device, a network interface, and optionally a graphics processing unit. The user connects image acquisition devices and acoustic acquisition devices, such as network cameras and microphones, to the server through a local area network. The user further registers guardians and educational workers as recipients by configuring information processing terminals such as smartphones, tablet computers, or personal computers.

In this embodiment, the server executes an operating system such as a general-purpose server operating system. The server stores the program as a set of executable modules and configuration files in a non-volatile storage device. The server uses a relational database system, such as a structured query language database, to store configuration information, raw data references, analysis results, integrated event information, evaluation values, risk levels, notification messages, and feedback information. The server further uses a multimedia library such as a video processing framework to decode image information and an image processing library such as a computer vision library to perform face detection, body motion analysis, and feature extraction. The server uses a speech recognition service, such as a cloud-based speech-to-text interface accessible via a communication protocol, to convert acoustic information into character information. The server uses a natural language processing service, such as a sentiment analysis module, to obtain emotion states and aggressiveness indices from character information.

In this embodiment, the server uses a generative AI model that is implemented as a neural network-based language model. The generative AI model may be a transformer-type architecture having multiple encoder-decoder layers or decoder-only layers, each layer including self-attention mechanisms, feed-forward networks, and normalization components. The generative AI model is trained in advance on a large corpus of natural language text by minimizing a prediction error function such as a cross-entropy loss between predicted tokens and ground-truth tokens. The generative AI model stores trainable parameters, including weight matrices and bias terms, in a parameter space with millions or billions of dimensions. The generative AI model is accessible to the server through an application programming interface, and the server transmits prompt sentences as input sequences of tokens and receives generated natural language text as output sequences of tokens.

In one mode, the server executes a preprocessing module that converts raw image information into a standardized data structure. The server divides image information into discrete frames and associates each frame with a timestamp and a device identifier. The server stores references to these frames as entries in the database. The server then applies a face detection algorithm, such as a convolutional neural network-based detector or a cascade classifier, to each frame to locate face regions. For each detected face region, the server computes a feature vector of numerical values representing spatial patterns, such as distances between facial landmarks and local texture descriptors. The server then inputs the feature vector into an emotion classification model, such as a neural network with multiple fully connected layers trained to output a probability distribution over expression categories. The server records the expression state and an associated confidence score for each face region.

In parallel, the server executes a body motion analysis module. The server applies a pose estimation algorithm, such as a deep learning-based model that predicts body keypoints, to selected frames. The server obtains coordinates of joints such as shoulders, elbows, hips, and knees and stores these as keypoint arrays. The server derives body motion states by analyzing temporal changes in the keypoint arrays across consecutive frames. For example, the server determines whether the displacement vectors of a child's arms exceed predetermined thresholds in a direction toward another child and labels such motion as a pushing action. The server aggregates the expression states and body motion states for each child candidate over a predetermined time unit, such as ten seconds, and stores the aggregated behavior information as structured data with fields including a time interval, a location identifier, a list of dominant expression states, and a set of detected body motion states.

In another mode, the server executes an acoustic preprocessing module that segments acoustic information into audio chunks of predetermined duration. The server invokes an audio normalization algorithm that adjusts amplitude levels and optionally removes background noise using filters such as spectral subtraction. The server transmits each audio chunk to a speech-to-text service using a secure network protocol and receives character information with associated confidence scores. The server stores the character information in the database in association with a time interval and a location. The server applies a sentiment and toxicity analysis algorithm to the character information. In one example, the server uses a neural text classifier that computes an embedding vector for each sentence and outputs an emotion state and an aggressiveness index. The server further extracts specific abusive phrases or threatening expressions by matching against a domain-specific lexicon or by using sequence labeling. The server aggregates these results for each time unit and stores the conversation information as structured data.

The server then executes an integration module that associates behavior information and conversation information with common time information and position information. The server constructs an internal data object, referred to as integrated event information, that includes identifiers of children or face tracks, aggregated expression states, aggregated body motion states, representative conversation extracts, emotion states, aggressiveness indices, and corresponding time intervals and locations. The server uses unique identifiers to link frames, audio chunks, and analysis results, and records the integrated event information in a database column that stores hierarchical data structures.

In one embodiment, the server executes a description generation module that converts integrated event information into a description text. The server composes sentences using a rule-based template system that maps numerical and categorical attributes of the integrated event information to phrases. For example, when a risk-related attribute exceeds a predetermined threshold, the server inserts a phrase such as “frequent angry expressions” or “repeated threatening language.” The server concatenates these phrases into a coherent description text in natural language. The server then constructs a prompt sentence by combining the description text with instructions to the generative AI model. An example of such a prompt sentence is:

“Analyze the following school interaction.

Time window: 2023 Oct. 5, 15:00:00-15:00:30.

Place: playground.

Child A's facial expression: angry (confidence 0.87) in most frames.

Child B's facial expression: fearful (confidence 0.82) and avoidance behavior detected.

Behavior: Child A pushed Child B twice.

Transcribed dialogue: ‘You're useless’, ‘I'll hit you if you tell anyone.’Toxicity score: 0.92.

Based on this information, assess the likelihood that this is bullying on a 0-100 scale, and explain your reasoning in 3-5 sentences.”

The server converts this prompt sentence into tokens and transmits them to the generative AI model through the interface. The generative AI model internally applies a sequence of attention operations, matrix multiplications, and nonlinear activation functions to compute context-dependent hidden representations for each token and predicts output tokens that form a natural language response. The model is configured such that one portion of the response includes an explicit evaluation value, such as “Bullying likelihood: 85/100,” and another portion includes an explanation. The server parses the response to extract the numeric evaluation value by searching for specially formatted patterns or by requesting an additional structured output segment. The server classifies the integrated event information into a risk level by comparing the evaluation value with a threshold stored in the database. For example, the server assigns a “high-risk” label when the evaluation value is equal to or larger than seventy.

The server also uses the generative AI model to generate notification messages. In one example, the server prepares another prompt sentence that includes the integrated event information and the risk level. Such a prompt sentence may be:

“Create a concise warning message for guardians and teachers about the following incident.

Incident summary: A high-risk interaction was detected on 2023 Oct. 5 at 15:00 on the playground. Child A showed repeated angry expressions and physically pushed Child B twice. Child B showed fearful expressions and avoidance behavior. The conversation included insults such as ‘You're useless’ and threats such as ‘I'll hit you if you tell anyone.’ The bullying likelihood score is 85/100.

Include: date, time, place, brief description of behaviors and speech, and a statement that there is a high likelihood of bullying. Write in clear, polite language.”

The server inputs this prompt sentence into the generative AI model and obtains a notification message that includes a warning text and behavioral guidelines. The server may further generate a separate prompt sentence to obtain detailed behavioral guidelines, for example:

“We detected a high likelihood of bullying in the following incident: [incident summary].

Propose concrete actions that guardians and teachers should take to protect the child and prevent escalation.

Provide 5-7 step-by-step recommendations, each in 1-2 sentences.”

The server stores the resulting notification messages in the database together with the integrated event information, evaluation values, and risk levels.

The terminal receives notification messages through one or more communication channels. In one embodiment, the terminal executes an application that periodically queries the server via an application programming interface to obtain new notification messages associated with a given guardian or educational worker. The terminal presents the warning text and the behavioral guidelines in a graphical user interface. The terminal may allow the user to scroll through time-ordered notification messages, filter by risk level or location, and view the underlying integrated event information such as dominant expression states, body motion states, and conversation extracts. The terminal may further provide user interface elements for the guardian or educational worker to submit post-response information and feedback information, such as whether the incident was confirmed as bullying or whether the proposed behavioral guidelines were helpful.

In this embodiment, the server executes a feedback management module that records post-response information and feedback information in association with the corresponding evaluation values and risk levels. The server executes learning control processing that analyzes the accumulated records to improve the configuration of prompt sentences and the parameters used to determine risk levels. For example, the server can compute a misclassification rate by comparing evaluation values flagged as high-risk with feedback indicating that no bullying occurred, and can adjust the threshold used for classification. Furthermore, the server can automatically modify the composition of prompt sentences by emphasizing attributes that correlate with confirmed bullying cases, such as aggressiveness indices or repeated threatening phrases, and de-emphasizing attributes that often lead to false positives. The server, by doing so, changes the internal distribution of token patterns presented to the generative AI model and thus causes the model to focus its attention on more relevant features when generating evaluation values and explanations, leading to an improvement in detection accuracy and stability.

From a technical standpoint, the described configuration improves computer technology over conventional systems in several ways. First, the server converts heterogeneous data streams of image information and acoustic information into a unified integrated event information structure that includes synchronized expression states, body motion states, and conversation information. This structured correlation reduces the need for repeated non-deterministic feature searches and enables the processor to access context-rich features with fewer database queries, thereby improving data management efficiency and reducing processing latency. Second, the use of a generative AI model in combination with specially constructed prompt sentences makes it possible to derive evaluation values and risk levels that consider joint patterns of multimodal data rather than isolated signals. Because the prompt sentences explicitly encode timing, location, emotion, and aggressiveness indices in natural language, the generative AI model can exploit its internal attention mechanisms to perform a kind of dynamic feature selection that would be difficult to implement by manual rule sets.

Third, the learning control processing that adjusts prompt sentence composition and determination conditions based on post-response information and feedback information realizes a non-conventional optimization loop at the computer level. Instead of merely retraining the model with additional labeled data, the server modifies upstream representations and threshold parameters. This modification alters the distribution of inputs in a controlled way, which in turn reduces variance in evaluation values and improves robustness without requiring full retraining. As a result, the system can maintain or improve accuracy with lower computational cost and network bandwidth, because the server can reduce the number of events that must be forwarded to the generative AI model by more effectively pre-filtering events.

Furthermore, the server implements specific algorithms that differ from human judgment processes. The server computes expression states using numerical feature vectors derived from pixel patterns and classifies them using trained neural classifiers based on optimization of loss functions, whereas a human observer would rely on subjective perception. The server evaluates aggressiveness indices using quantitative metrics extracted from transcribed text and acoustic features, including word frequency of abusive terms and estimates of prosodic intensity, and integrates these metrics over time windows according to predefined mathematical rules. These algorithmic operations, combined with the structured prompting and feedback-driven adjustment mechanisms, result in technical effects such as reduced false positives, faster risk assessment per event, and improved stability of risk categorization under varying environmental noise and lighting conditions.

In variations of this embodiment, the server may execute all modules on a single physical machine, or may distribute different modules across multiple machines in a cloud environment. In another variation, the generative AI model may run locally on a graphics processing unit installed in the server, in which case the server stores the model parameters in local storage and executes forward passes using a deep learning runtime library. In another variation, the server may use different image analysis or speech analysis algorithms, such as alternative neural network architectures or classical signal processing algorithms, while maintaining the overall data structures for integrated event information and prompt sentences. In yet another variation, the server may adjust the duration of time windows, the granularity of expression states, or the scale of aggressiveness indices according to application requirements, such as different age groups or different types of monitored environments.

In all of these embodiments, the server, the terminal, and the user cooperate so that the system provides a concrete technical implementation that transforms raw sensory data into structured integrated event information, uses a generative AI model through carefully designed prompt sentences to compute evaluation values and generate context-aware notification messages, and iteratively refines its own internal decision parameters based on feedback. This configuration enables the system to achieve improved detection precision, reduced processing overhead, and more effective utilization of computing resources, beyond mere automation of human observation.

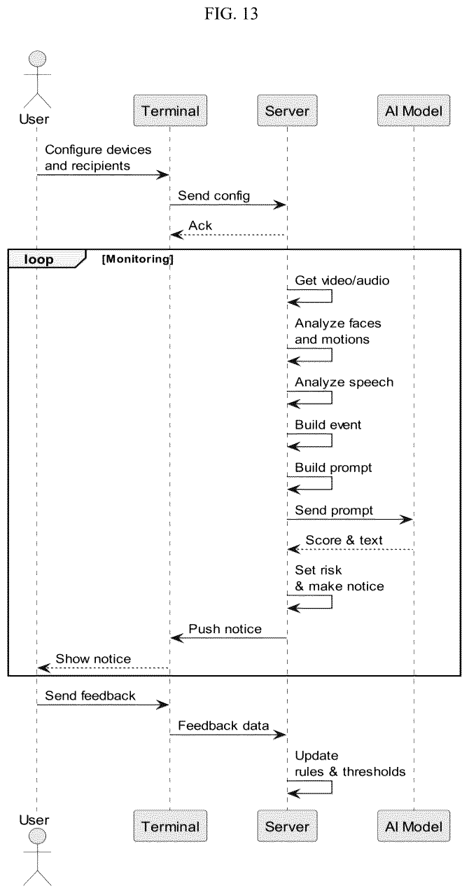

The following describes the processing flow using FIG. 13.

### Step 1

Server acquires configuration input from the user and initializes system resources.

Server receives, as input, device registration data from the user via a web interface, including identifiers and network addresses of cameras and microphones, location labels for each device, monitoring schedules, and recipient account information for guardians and educational workers.

Server stores this input into configuration tables of a database and allocates internal identifiers for each device and each monitored area.

Server performs data processing by validating network connectivity to each device, writing configuration records, and loading required software modules (image analysis, speech analysis, database connectors, generative AI client).

Server outputs an initialized configuration state containing device maps, schedule rules, and recipient mappings that will be referenced by subsequent processing steps.

### Step 2

Server acquires raw image information and acoustic information from the registered devices.

Server receives, as input, continuous video streams from cameras and continuous audio streams from microphones over network protocols.

Server performs data processing by decoding compressed video into frames using a multimedia library and by buffering raw audio samples into fixed-size blocks. Server attaches time information and position information to each frame and audio block based on system time and device configuration.

Server outputs time-stamped frame records and time-stamped audio block records, each associated with device identifiers and location identifiers, and stores references to these records in the database.

### Step 3

Server preprocesses video frames to create normalized image data.

Server takes, as input, the time-stamped frame records from Step 2.

Server performs data processing by resizing each frame to a standard resolution, converting color space formats, and applying noise-reduction filters such as Gaussian blur. Server may compress or format the preprocessed frames into an internal image representation optimized for subsequent analysis.

Server outputs a sequence of normalized frames with metadata indicating timestamps, locations, and frame identifiers, and writes these to a temporary storage buffer or cache.

### Step 4

Server detects face regions and computes expression states for each face.

Server takes, as input, the normalized frames from Step 3.

Server performs data processing by applying a face detection algorithm to each frame to identify bounding boxes for face regions. For each detected face, server extracts pixel patches and computes feature vectors using an emotion classification model. Server applies a neural network-based classifier to the feature vectors to obtain an expression category and a confidence score.

Server outputs face analysis records that include time information, position information, face identifiers, expression states, and confidence values, and stores these records in the database.

### Step 5

Server analyzes body motion states from sequences of frames.

Server takes, as input, the normalized frames from Step 3 and associated time information.

Server performs data processing by executing a pose estimation algorithm that detects keypoints for each visible person in the frame, and then tracks the keypoints of the same person across consecutive frames. Server computes velocity vectors and displacement patterns of keypoints over time and applies rule-based or model-based criteria to label motion states, such as approaching, pushing, or avoiding.

Server outputs body motion records that include time intervals, location identifiers, person track identifiers, and body motion state labels with confidence scores, and saves these records as structured behavior information.

### Step 6

Server segments and preprocesses acoustic information into audio chunks.

Server takes, as input, the time-stamped audio block records from Step 2.

Server performs data processing by grouping audio blocks into larger audio chunks of predetermined duration, normalizing amplitudes, and optionally removing background noise using spectral analysis. Server encodes each audio chunk into a format acceptable by a speech-to-text service.

Server outputs preprocessed audio chunk files with associated time intervals and location identifiers, and registers them in the database.

### Step 7

Server converts audio chunks into character information using speech analysis.

Server takes, as input, the preprocessed audio chunks from Step 6.

Server performs data processing by sending each audio chunk to a speech-to-text service via a network request, receiving transcribed text and confidence scores, and aligning the resulting text with the corresponding time interval and location.

Server outputs transcription records that contain character information, timestamps, locations, and recognition confidence, and stores these records as raw conversation text.

### Step 8

Server computes emotion states and aggressiveness indices from character information.

Server takes, as input, the transcription records from Step 7.

Server performs data processing by applying a sentiment and toxicity analysis algorithm to each text segment. Server converts the text into vector representations, evaluates an emotion state (e.g., calm, angry, mocking), and computes an aggressiveness index based on occurrences of abusive expressions and intensity of negative sentiment.

Server outputs conversation analysis records that include emotion states, aggressiveness indices, detected abusive phrases, and associated metadata, and stores these records as structured conversation information.

### Step 9

Server aggregates behavior information and conversation information into integrated event information.

Server takes, as input, face analysis records and body motion records from Steps 4 and 5, and conversation analysis records from Step 8.

Server performs data processing by grouping these records into common time windows and locations, and by correlating person tracks and conversation segments where possible. Server constructs integrated event objects that summarize, for each time interval and area, dominant expression states, body motion states, representative conversation extracts, emotion states, and aggressiveness indices.

Server outputs integrated event information entries, each containing a unified representation of multimodal data for an interaction event, and writes these entries to the database.

### Step 10

Server generates a description text and constructs a prompt sentence for the generative AI model.

Server takes, as input, each integrated event information entry from Step 9.

Server performs data processing by applying a template-based or rule-based text generation module that converts numerical values and categorical labels into phrases and sentences. Server then assembles these sentences into a description text in natural language. Server constructs a prompt sentence by embedding the description text together with explicit instructions to assess bullying likelihood and to provide reasoning.

Server outputs a prompt sentence string for each integrated event, ready to be transmitted to the generative AI model.

### Step 11

Server evaluates the possibility of bullying by using the generative AI model.

Server takes, as input, the prompt sentence from Step 10.

Server performs data processing by tokenizing the prompt sentence, sending the token sequence to the generative AI model via an interface, and receiving an output sequence that includes a narrative explanation and a numeric evaluation value. Server parses the output text to extract the evaluation value, such as a score on a 0-100 scale, and interprets the explanation portion as auxiliary reasoning information.

Server outputs evaluation records that contain the evaluation value, the explanation text, and a reference to the corresponding integrated event, and stores these records in the database.

### Step 12

Server assigns a risk level to each integrated event based on the evaluation value.

Server takes, as input, the evaluation records from Step 11 and threshold parameters from configuration data.

Server performs data processing by comparing each evaluation value to one or more thresholds to classify the corresponding event into categories such as low-risk, medium-risk, or high-risk. Server may also apply additional logic, such as considering aggressiveness indices or repeated occurrences, when assigning risk levels.

Server outputs updated integrated event information that includes a risk level field, and records the classification in the database.

### Step 13

Server generates a notification message including a warning text and behavioral guidelines.

Server takes, as input, the integrated event information with assigned risk levels from Step 12.

Server performs data processing by constructing a new prompt sentence that includes the event summary and risk level and instructs the generative AI model to produce a concise warning text and recommended actions. Server transmits this prompt sentence to the generative AI model, receives a natural language response, and, if necessary, post-processes the text to ensure clarity and appropriate tone.

Server outputs notification message records that contain the warning text, behavioral guidelines, and references to the corresponding event and recipients, and stores these records in the database.

### Step 14

Server prepares and routes notifications to terminals of guardians and educational workers.

Server takes, as input, the notification message records from Step 13 and the recipient mappings from Step 1.

Server performs data processing by formatting messages for different channels, such as email or push notifications, and inserting event identifiers and risk levels into message payloads. Server schedules or triggers transmission through communication services and logs the status of each notification.

Server outputs transmitted message data to external communication systems and updates delivery status fields in the database for each recipient.

### Step 15

Terminal receives and displays notification messages to users.

Terminal takes, as input, incoming notifications from the server via network protocols or push services.

Terminal performs data processing by decoding the message payload, retrieving additional event details from the server if needed, and rendering the warning text and behavioral guidelines in a user interface. Terminal may highlight high-risk events using visual markers and allow the user to navigate to historical event summaries.

Terminal outputs a visual and, optionally, audible presentation of the notification message, enabling guardians and educational workers to perceive and understand the risk assessment.

### Step 16

User reviews notifications and provides post-response information and feedback.

User takes, as input, the displayed notification messages and event details presented on the terminal.

User performs data processing in a human cognitive manner by evaluating the content, confirming or refuting the presence of bullying, and deciding which actions to take. User then enters post-response information and feedback information into the terminal through input controls such as forms or buttons.

Terminal outputs this user-generated data as structured feedback records and transmits them to the server.

### Step 17

Server updates prompt configuration and decision parameters based on feedback.

Server takes, as input, the feedback records and post-response information from Step 16, together with the corresponding evaluation values and risk levels from previous steps.

Server performs data processing by correlating evaluation outcomes with real-world confirmations or corrections provided by the user. Server computes error metrics such as false positive and false negative rates and adjusts thresholds or weighting factors accordingly. Server updates rules that determine which attributes are emphasized or de-emphasized in constructing future prompt sentences, thereby modifying the structure and content of prompt sentences in a data-driven manner.

Server outputs revised configuration parameters and prompt construction rules, which are stored in the database and used as new input conditions for subsequent executions of Steps 10 through 13, improving detection accuracy and stability over time.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional bullying-detection systems typically rely on simple rule-based classifiers or single-modal analysis, such as processing only still images or only text logs. Such systems suffer from multiple technical deficiencies when implemented on modern computing platforms.

First, existing systems generally process image data and acoustic data in separate, loosely coupled pipelines. As a result, a processor cannot construct consistent, time-aligned multimodal feature sequences that jointly represent emotional states and behavioral states of a child. This separation leads to information loss and unstable model outputs, and forces the processor to repeatedly re-scan raw data streams, which increases memory usage and processing latency.

Second, many systems treat each frame or each utterance as an independent sample, without employing robust time-series analysis. In such architectures, the processor does not maintain coherent, per-individual behavior feature sequences and audio feature sequences over time. Consequently, the processor fails to detect temporal patterns such as gradual escalation, repeated isolation, or sustained negative affect, and instead depends on instantaneous thresholds that are prone to noise and false alarms. This causes inefficient use of computational resources and yields poor predictive performance.

Third, conventional systems lack a structured interface between low-level detection components and high-level explanation components. In particular, the processor does not generate standardized structured event information nor optimized prompt sentences for a generative AI model. As a result, when a generative AI model is used at all, the processor must repeatedly encode raw or semi-raw data into ad hoc textual descriptions, which increases processing overhead, degrades reproducibility, and often produces explanations and warning messages that are inconsistent or not aligned with the underlying model outputs.

Fourth, prior systems do not effectively integrate user feedback into a continuous self-learning loop. Although some systems allow guardians or educational workers to review incidents, the processor typically stores such feedback in an unstructured format that is not linked back to the multimodal features or risk evaluation results. This prevents the machine learning models and time-series analysis models from being incrementally refined using real-world labels. Consequently, the computing system cannot systematically reduce false positives and false negatives, and cannot improve accuracy and robustness over time.

Fifth, notification generation and presentation logic in known systems are usually static. The processor does not dynamically adjust urgency, expression intensity, or the content of suggested response plans based on quantified risk, detected emotional and behavioral states, and accumulated review information. This leads to one-size-fits-all warning messages that either over-alert users, causing alert fatigue, or under-communicate critical situations, resulting in delayed or inadequate interventions.

Accordingly, there is a need for a technical architecture in which a processor is configured to: (i) perform integrated preprocessing of time-series image information and acoustic information; (ii) build synchronized behavior feature sequences and audio feature sequences using machine learning models and time-series analysis models; (iii) generate standardized structured event information and optimized prompt sentences as an interface to a generative AI model; (iv) capture and link review information or label information from terminal devices to the underlying structured data; and (v) use this linked information to drive a self-learning loop and dynamic control of notification content. By solving these computer-centric problems, the invention improves the functioning of the processor itself, enabling more accurate and efficient detection, explanation, and notification of bullying-related risk in a computing environment.

The specific processing by the specific processing unit 290 of the data processing device 12 in Application Example 2 is realized by the following means.

The present invention provides a server comprising a processor configured to receive time-series image information and acoustic information from an observation device, to perform preprocessing on the image information by an image processing technique in order to normalize pixel information, and to perform preprocessing on the acoustic information by a signal processing technique in order to extract voice features in a time domain or a frequency domain; to detect a human region in the preprocessed image information by using an object recognition algorithm and a tracking algorithm, to associate the human region with time-series positions, and to generate feature information with individual identification information; to extract a facial region and a body region from the human region, to extract facial feature quantities and posture feature quantities by using a machine learning model, and to generate a behavior feature sequence by aggregating the feature quantities in a time direction; to perform a speech recognition process and an emotion estimation process on the acoustic information, to extract utterance content information, voice emotion feature quantities, and utterance manner feature quantities of a speaker, and to generate an audio feature sequence in a time series; to integrate the behavior feature sequence and the audio feature sequence, to estimate, by using a time-series analysis model, a plurality of emotional states and behavioral states of a child over time, and to calculate probability information or risk evaluation information indicating a possibility of bullying based on an estimation result; to generate structured event information regarding a situation when the probability information or the risk evaluation information satisfies a predetermined condition, and to automatically generate a prompt sentence to be input to a generative AI model based on the structured event information; to input the prompt sentence and the structured event information to the generative AI model, and to generate, by natural language processing, text information including explanatory information regarding the possibility of bullying, a warning message, and at least one response plan; to convert the text information into notification information to be transmitted to a user display device, and to transmit the notification information to a terminal device of a guardian or an educational worker; and to store review information or label information input from the terminal device in association with the structured event information and the probability information or the risk evaluation information, and to reuse the stored information as learning data for the machine learning model and the time-series analysis model so as to form a self-learning loop for continuously improving detection accuracy of the possibility of bullying. This enables the computing system to perform multimodal, time-series bullying-risk estimation with reduced latency and improved robustness, to generate consistent and context-appropriate warning messages and response plans through an optimized interface to a generative AI model, and to automatically refine its internal models over time based on structured user feedback, thereby improving the technical performance of the processor and the overall effectiveness of bullying detection and notification.

The term “time-series image information” refers to a sequence of image data elements, such as frames of video, that are temporally ordered and associated with time information indicating when each image was captured.

The term “acoustic information” refers to audio data acquired over time, including sound signals such as speech, environmental noise, and other audible events, which are represented in a digital form suitable for signal processing.

The term “observation device” refers to any hardware apparatus configured to capture one or more types of sensor data, including at least image information and/or acoustic information, such as a camera device, a microphone device, or a composite sensor unit.

The term “image processing technique” refers to a computational procedure that operates on digital image data to modify, analyze, or transform pixel values, including operations such as normalization, noise reduction, resizing, and color-space conversion.

The term “pixel information” refers to numerical values representing individual picture elements in a digital image, including intensity values, color components, or other attributes assigned to each pixel location.

The term “signal processing technique” refers to a computational procedure that operates on time-varying signals, such as audio waveforms, to extract, transform, or analyze features in the time domain or frequency domain.

The term “voice features in a time domain or a frequency domain” refers to quantitative descriptors of an audio signal derived from temporal or spectral analysis, such as energy, pitch, formants, spectral coefficients, or other parameters representing characteristics of speech.

The term “human region” refers to a portion of an image corresponding to at least part of a human subject, such as a full body, an upper body, or a localized area containing a person.

The term “object recognition algorithm” refers to a computational method that processes image data to detect and identify objects, including persons, by locating their regions and assigning classification labels or confidence scores.

The term “tracking algorithm” refers to a computational method that associates detected objects across multiple frames of image data so as to estimate their trajectories and maintain consistent identities over time.

The term “individual identification information” refers to data that distinguishes one detected subject from another within a scene or across time, such as an identifier assigned to a particular tracked human region.

The term “facial region” refers to a subregion of an image that includes at least a portion of a human face suitable for analysis of facial characteristics.

The term “body region” refers to a subregion of an image that includes at least a portion of a human body, excluding or in addition to the facial region, suitable for analysis of posture or movement.

The term “machine learning model” refers to a computational model whose parameters are obtained or refined through a data-driven training process, and which is configured to map input data to output predictions or feature representations.

The term “facial feature quantities” refers to numerical values derived from a facial region that represent characteristics such as facial landmarks, muscle activations, expression-related descriptors, or other features indicative of emotional or physical state.

The term “posture feature quantities” refers to numerical values derived from a body region that represent characteristics such as joint positions, body orientation, or motion vectors, indicative of human posture or behavior.

The term “behavior feature sequence” refers to a sequence of feature vectors that represents temporal evolution of facial and posture feature quantities for an individual over a period of time.

The term “speech recognition process” refers to a computational operation that converts acoustic information containing speech into a symbolic representation such as text or phonetic units.

The term “emotion estimation process” refers to a computational operation that analyzes input data, such as acoustic information or image information, to infer one or more emotional states of a person.

The term “utterance content information” refers to textual or symbolic data representing the linguistic content of speech derived from the speech recognition process.

The term “voice emotion feature quantities” refers to numerical values representing emotional characteristics inferred from an audio signal, including parameters related to prosody, intensity, pitch variation, or other emotion-related attributes.

The term “utterance manner feature quantities” refers to numerical values that describe how speech is delivered, including features such as speaking rate, pauses, emphasis, or other attributes related to manner of speaking.

The term “audio feature sequence” refers to a sequence of feature vectors that represents temporal evolution of acoustic characteristics, including voice emotion feature quantities and utterance manner feature quantities, over time.

The term “time-series analysis model” refers to a machine learning or statistical model configured to process ordered sequences of data elements and to capture temporal dependencies, such as a recurrent neural network, a temporal convolutional model, or another sequential model.

The term “emotional states” refers to psychological conditions of an individual, such as happiness, sadness, anger, fear, or neutrality, inferred from one or more sensor modalities.

The term “behavioral states” refers to conditions or patterns of physical actions or interactions of an individual, such as isolation, confrontation, avoidance, or engagement, inferred from observable behavior.

The term “probability information” refers to numerical values representing likelihoods associated with one or more events or conditions, such as a probability that bullying is occurring.

The term “risk evaluation information” refers to data indicating an assessment of risk level for a given event or condition, which may include scores, categories, or other quantitative indicators.

The term “structured event information” refers to data formatted according to a predefined schema that summarizes attributes of a detected situation, including at least identifiers, time information, location information, emotional states, behavioral states, and risk evaluation information.

The term “prompt sentence” refers to a textual input provided to a generative AI model that specifies instructions, context, or data for generation of an output text.

The term “generative AI model” refers to a computational model, such as a large language model, that is trained to produce new textual or other content in response to input data including a prompt sentence.

The term “explanatory information regarding the possibility of bullying” refers to natural-language text that describes, interprets, or clarifies circumstances and reasons related to a detected bullying risk.

The term “warning message” refers to natural-language text that alerts a recipient to a potential or detected risk, such as a risk of bullying, and may indicate urgency or required attention.

The term “response plan” refers to one or more recommended actions or strategies to be taken by a user, such as a guardian or an educational worker, in response to a detected bullying risk.

The term “text information” refers to data expressed in human-readable natural language, including explanatory information, warning messages, and response plans generated by the generative AI model.

The term “notification information” refers to data formatted for transmission to a user interface, including at least part of the text information and associated metadata, for the purpose of informing a user about a detected event.

The term “user display device” refers to any apparatus having a visual output interface configured to present information to a human user, such as a terminal device, a monitor, or a portable communication device.

The term “terminal device” refers to an endpoint computing device operated by or accessible to a user, such as a handheld device, a wearable device, or a stationary computer system, capable of receiving notifications and transmitting user input.

The term “guardian” refers to a person having responsibility for the welfare of a child, including a parent, legal custodian, or other caretaker.

The term “educational worker” refers to a person engaged in educational or supervisory activities for children, including teachers, counselors, or administrative staff.

The term “review information” refers to user-provided data expressing an assessment or evaluation of a detected event, such as confirmation of bullying, identification of a false alarm, or comments regarding context.

The term “label information” refers to structured annotation data provided by a user that assigns one or more classification labels to an event, such as categories indicating bullying, non-bullying conflict, or normal behavior.

The term “learning data” refers to data used to train or update a machine learning model, including input features and associated labels or target values.

The term “self-learning loop” refers to a process in which a system automatically incorporates new data and feedback into model training or updating, thereby improving model performance over time without manual reprogramming.

The term “management screen” refers to a graphical user interface view that aggregates and displays organized information about multiple events, states, and risk levels in a format suitable for oversight and analysis.

The term “display control interface” refers to a functional component that manages how information is presented on a user display device and how user input related to navigation, filtering, or selection of displayed information is handled.

The term “urgency” refers to a measure representing how quickly attention or action is required in response to a detected event, such as a bullying risk event.

The term “expression intensity” refers to a degree or strength of language used in a warning message, such as the level of emphasis or seriousness conveyed in the text.

The term “control parameters” refers to numerical or categorical values used to adjust behavior of the system, including generation of warning messages and response plans, based on internal state or input data.

The term “optimize input content to the generative AI model” refers to the act of configuring or modifying the prompt sentence and associated data in a way that improves the relevance, clarity, or usefulness of the output generated by the generative AI model.

In one or more embodiments, a system includes a server, one or more terminals, and one or more observation devices such as cameras and microphones installed in environments where children are present. The observation devices are configured to capture time-series image information and acoustic information, and the terminals are configured to transmit the captured information to the server and to display notifications and analysis results. The server includes at least one processor, a memory storing executable instructions, and one or more communication interfaces.

Server uses the processor and memory to execute a program that implements a multimodal bullying-risk estimation pipeline. Server receives digitized video streams and audio streams from terminals via a secure network connection, for example over a packet-based network using a secure transport protocol. Server stores incoming data in a structured buffer, for example as a set of records each containing a session identifier, a timestamp, an image frame, and an associated segment of acoustic samples.

Server applies an image processing module implemented with a general-purpose image processing library, for example a library implementing functions analogous to those of OpenCV. Server converts each frame into a normalized pixel representation: server resizes each frame to a fixed resolution such as 224×224 pixels, converts the color space to a standard representation such as RGB or YUV, and normalizes pixel values to a predefined numeric range. Server optionally applies spatial filters such as Gaussian blurring and contrast-limited adaptive histogram equalization to reduce noise and stabilize illumination. By performing these operations on the server side using vectorized instructions and hardware acceleration, server improves consistency of input data and reduces downstream computational overhead compared to performing the same operations ad hoc at the application level.

Server uses a signal processing module to operate on the acoustic information. Server segments audio into overlapping windows of fixed duration, such as 1 second with 50% overlap, and applies a digital filter to remove low-frequency noise. Server computes short-time Fourier transforms of the windows and derives acoustic feature vectors, for example Mel-frequency cepstral coefficients, energy, zero-crossing rate, and pitch-related features. Server aggregates these acoustic features per segment and associates them with corresponding frame timestamps. This structured association avoids repeated scanning of the raw audio stream and reduces memory bandwidth consumption.

Server executes an object detection module implemented as a convolutional neural network. In one embodiment, server uses a detector having a backbone convolutional network with multiple layers of convolutions, batch normalization, and nonlinear activation functions such as rectified linear units, and a detection head that outputs bounding boxes and class scores for human regions. Server processes each normalized frame through this detector, obtains candidate bounding boxes, filters them based on confidence thresholds, and outputs human regions likely to correspond to children or other persons in the scene.

Server executes a tracking module that associates detected human regions across consecutive frames. The tracking module may maintain state vectors comprising position, velocity, and appearance features for each tracked subject, and update these vectors using a prediction-correction mechanism such as a Kalman filter combined with an appearance-based matching metric derived from an embedding network. Server assigns unique individual identification information to each track and stores a mapping from track ID to a sequence of frames and bounding boxes. This design enables server to maintain continuous behavioral histories per individual, which improves temporal consistency and decreases the need for repeated re-identification computations.

Server extracts facial regions and body regions from each human region. Server applies a face localization network to identify locations of key facial landmarks such as eyes, nose, and mouth corners, and uses these landmarks to crop and align a facial patch. Server defines a body region, for example as an expanded bounding box below the facial region, for posture analysis. Server then feeds the facial region to an emotion recognition network and the body region to a posture and action recognition network.

Server implements the emotion recognition network as a convolutional neural network trained on facial images annotated with emotion labels such as happiness, sadness, anger, fear, and neutrality. The network may include convolutional layers, pooling layers, and fully connected layers, and is trained using a loss function such as cross-entropy between predicted emotion distributions and ground-truth labels. Server feeds each aligned facial region through this network and obtains a vector of facial feature quantities representing, for example, activations of intermediate layers and a probability distribution over emotion categories. This network structure allows server to extract robust, low-dimensional emotion descriptors that are less sensitive to noise and pose variations than raw pixels, thereby improving classification accuracy and reducing computational load.

Server implements the posture and action recognition network as a model that may include a pose estimation front end and a temporal classification back end. Server executes the pose estimation front end to detect positions of body joints such as shoulders, elbows, and knees, and encodes these as joint-coordinate vectors. Server feeds sequences of these joint-coordinate vectors into a temporal model such as a one-dimensional convolutional network or a recurrent neural network, which is trained to output behavior labels such as isolation, pushing, hitting, surrounding, or avoidance. By operating on structured joint coordinates rather than raw images, the network reduces the dimensionality of the data and enables more efficient temporal modeling within the server.

Server aggregates the facial feature quantities and posture feature quantities per individual into a behavior feature sequence. Server stores this sequence as a time-indexed array for each track ID, where each element includes an emotion feature vector and a posture feature vector. Server maintains a sliding temporal window over these sequences to support real-time updates.

Server executes a speech recognition module that converts acoustic information into text. In one embodiment, server uses an automatic speech recognition engine that outputs a lattice or a transcript with time-aligned word boundaries. Server stores the utterance content information together with timestamps, which can be aligned with image frames and behavior features. Server further processes the acoustic features and the transcript using an emotion estimation module that may be implemented as a neural network taking as input spectral features, prosodic features, and lexical features derived from the transcript. The module outputs voice emotion feature quantities and utterance manner feature quantities, such as speaking rate, pitch variability, and emphasis. Server arranges these into an audio feature sequence aligned with the behavior feature sequence.

Server integrates the behavior feature sequence and the audio feature sequence by constructing a multimodal feature sequence. In one example, server concatenates the facial emotion features, posture features, voice emotion features, and utterance manner features at each time step to form a single feature vector. Server then normalizes these multimodal feature vectors across a batch using learned scaling parameters. This data structure allows a time-series analysis model to exploit cross-modal correlations, such as simultaneous angry voice and confrontational posture, which improves the discriminative power of the model.

Server executes a time-series analysis model that may be implemented as a recurrent neural network, such as a long short-term memory network or a gated recurrent unit network, or as a transformer-based sequence model with self-attention layers. The model is trained to receive sequences of multimodal feature vectors and output, at each time step or for an entire time window, scores representing emotional states and behavioral states, and a probability that bullying is occurring. Server trains this model using labeled training sequences and an objective function such as a combination of cross-entropy for bullying classification and auxiliary losses for predicting emotion and behavior categories. Server updates model parameters using gradient-based optimization such as stochastic gradient descent with momentum or adaptive learning rate methods. Server may also apply data augmentation techniques such as temporal cropping, noise injection in audio features, and small geometric perturbations of pose coordinates to increase robustness.

Server calculates probability information or risk evaluation information based on the outputs of the time-series analysis model. Server may transform raw model outputs through a calibration layer, such as a temperature-scaled softmax or a logistic function, to produce a normalized risk score between zero and one. Server compares the risk score to one or more thresholds and evaluates additional conditions such as duration of elevated risk and presence of specific emotion combinations. When the conditions are satisfied, server generates structured event information.

Server represents structured event information using a predefined schema stored in memory. For example, server generates a record that includes: an event identifier, a child identifier, a time range, a location identifier corresponding to the observation device, a list of dominant emotional states with associated scores, a list of dominant behavioral states with associated scores, excerpts from speech transcripts, selected representative frames or frame identifiers, and the final risk evaluation information. By encoding events in this structured format, server avoids repeatedly scanning raw media data for every downstream operation and improves efficiency of subsequent processing such as query, storage, and explanation generation.

Server automatically generates a prompt sentence to be input to a generative AI model based on the structured event information. Server constructs the prompt by inserting values from fields of the structured event information into a template, or by composing segments that describe roles, times, locations, detected emotions, behaviors, and risk levels. An example of such a prompt sentence is:

“Event data: child_role=victim, time_range=10:20-10:23, location=playground, visual_emotions={sad:0.82, fear:0.64}, behaviors={‘surrounded_by_peers’, ‘avoiding_eye_contact’}, speech_analysis={‘insults_detected’:true}. Generate a concise explanation of what likely happened and propose concrete countermeasures for teachers and guardians in simple English.”

Server can generate different types of prompt sentences for different purposes. For example, when server is configured to design or improve system behavior, server may generate a prompt sentence such as:

“We have a bullying-detection system using multimodal time-series analysis on classroom video and audio data. We want to add long-term social isolation detection over several weeks. Suggest concrete features, sequence models, data aggregation strategies, and evaluation metrics, and show how to integrate them with the existing real-time pipeline.”

Server sends the prompt sentence and optionally an encoded representation of the structured event information to a generative AI model. The generative AI model may be a large language model running on the same hardware or on a remote computing platform, trained to generate natural-language text given a prompt. Server communicates with the generative AI model via an application programming interface and receives output text.

Server uses the received text as text information including explanatory information regarding the possibility of bullying, a warning message directed to a user, and at least one response plan suggesting specific actions. Server can post-process the generated text by truncating length, normalizing terminology, or adjusting style to conform with safety and policy guidelines. Server composes notification information by combining the text information with metadata such as identifiers and timestamps.

Server transmits notification information to terminals via a communication interface. Each terminal is a device operated by a guardian or an educational worker, such as a handheld communication device, a portable computing device, or a workstation. Terminal executes an application that receives notification information, displays the warning message and response plan on a screen, and allows user interaction. Terminal can show simplified risk indicators, for example by using color codes or numeric scales, and provide access to more detailed structured event information via an interactive interface.

User, acting as a guardian or an educational worker, operates the terminal to review the notification information. User may inspect the explanation, review representative images or summarized transcripts, and confirm or dispute whether bullying occurred. Terminal provides user interface elements enabling user to input review information or label information, such as selecting “confirmed bullying,” “no bullying,” or “uncertain,” and adding free text comments.

Terminal transmits the review information or label information back to server. Server associates this information with the corresponding structured event information and the underlying multimodal feature sequences and model outputs, and stores it in a repository as learning data. Server periodically or continuously uses the accumulated learning data to update the parameters of the machine learning model and the time-series analysis model. Server may separate data into training, validation, and test sets, compute gradients of a loss function that penalizes misclassification of bullying events as well as misclassification of non-bullying events, and update model weights accordingly. Server may also adjust thresholds used in risk evaluation and notification generation based on measured false positive and false negative rates.

By creating and maintaining this self-learning loop, server improves the detection accuracy and reduces computational waste. Because server stores and reuses structured feature representations and event summaries, rather than raw video and audio for each training iteration, server reduces storage requirements and accelerates batch training by avoiding repeated feature extraction. This architecture constitutes an improvement in computer technology, namely, more efficient and accurate machine learning-based analysis of streaming sensor data.

In one embodiment, server implements the components described above as separate modules organized into a pipeline: a data ingestion module, an image preprocessing module, an audio preprocessing module, an object detection and tracking module, a facial emotion recognition module, a posture and action recognition module, a speech recognition and acoustic emotion analysis module, a multimodal feature fusion module, a sequence modeling module for risk estimation, an event structuring module, a prompt generation module, a generative AI integration module, a notification delivery module, and a feedback integration and model-update module. Each module communicates via defined data structures, such as arrays of feature vectors and event records, enabling modular design and optimization.

In another embodiment, server may employ different neural network architectures, such as transformer-based encoders for video sequences and attention mechanisms linking audio and visual streams. Server may also employ alternative feature sets, such as embeddings derived from self-supervised learning on large unlabeled datasets, or may use graph-based representations of social interactions between multiple children. These variations allow the system to be adapted to different deployment environments and hardware constraints while preserving the core structure: integrated multimodal time-series analysis, structured event generation, optimized prompt sentence creation for a generative AI model, and a feedback-driven self-learning loop.

Server may use specialized hardware accelerators such as graphics processing units or dedicated neural network processors to execute the neural network modules. By distributing computation across such accelerators and optimizing memory layouts, server reduces processing latency and allows near real-time analysis of incoming streams. The ability to process data in real time and to maintain synchronized multimodal feature sequences enables server to detect short-lived but critical patterns of behavior that would be difficult to identify with slower or less integrated architectures.

Terminal, in some embodiments, may perform part of the preprocessing locally, such as encoding video and audio streams into compressed formats or performing lightweight detection of faces to focus transmission on regions of interest. This reduces network bandwidth usage and decreases the amount of data that server must decode and process. In other embodiments, terminal may simply function as a capture and display device, and server performs all heavy processing.

User, in some embodiments, may configure system parameters through a management interface presented on a terminal. User may adjust notification thresholds, specify which types of events should be highlighted, or define access policies. Server stores these configurations and uses them as inputs when calculating risk evaluation information and generating prompt sentences and notifications.

By combining specific neural network architectures, defined feature sets, structured data representations, and a generative AI model interface based on automatically constructed prompt sentences, this system implements technical measures that go beyond simple automation of human tasks. The server reduces redundancy in feature computation, manages multimodal streams efficiently, and provides a reproducible interface between statistical sequence models and natural-language generation. This yields quantifiable improvements in detection precision and recall, reduces latency in risk evaluation, reduces communication and storage overhead through structured representations, and enables continual adaptation of the models based on real-world feedback, thereby improving the functioning of the computer system itself.

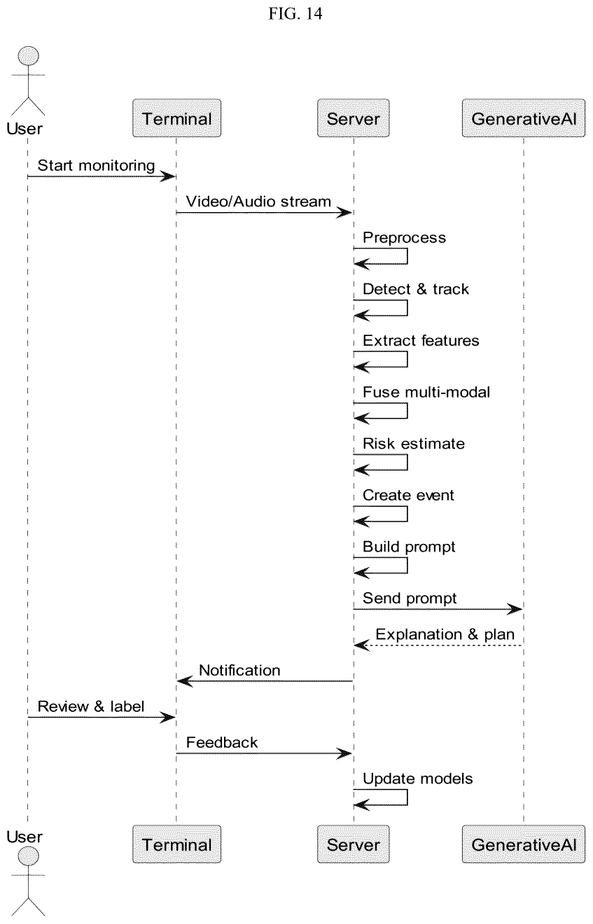

The following describes the processing flow using FIG. 14.

### Step 1

Terminal captures time-series sensor data.

Terminal uses an integrated camera and microphone to capture image frames and acoustic samples in real time.

Input: physical light and sound in the environment.

Terminal converts the light into digital image frames at a fixed frame rate (for example, 15-30 frames per second) and converts the sound into a digital audio stream with a fixed sampling rate (for example, 16 kHz).

Terminal buffers several frames and corresponding audio samples in local memory, compresses the image frames using a video codec and compresses the audio using an audio codec, and appends metadata such as device identifier, approximate location, and timestamps to each data segment.

Output: encoded data segments each including compressed video, compressed audio, and metadata.

### Step 2

Terminal transmits encoded data to the server.

Terminal establishes a secure network connection using a transport protocol with encryption and authentication.

Input: encoded data segments generated in Step 1.

Terminal divides the data into packets, attaches session identifiers, and sends the packets over the network in chronological order.

Terminal may drop or downsample frames when network bandwidth becomes constrained, thereby performing a basic communication load reduction.

Output: network packets carrying time-ordered multimedia data and metadata addressed to the server.

### Step 3

Server receives and decodes multimedia streams.

Server listens on a network interface, authenticates the terminal using stored credentials, and reconstructs the original sequence of data segments from received packets.

Input: network packets from one or more terminals.

Server decodes compressed video into individual image frames and decodes compressed audio into digital audio samples by applying video and audio decoding algorithms.

Server attaches unified timestamps to each frame and each audio segment and stores them in a time-ordered buffer associated with a session identifier.

Output: synchronized raw image frames and raw audio segments organized per session and timestamp.

### Step 4

Server performs low-level preprocessing on image and audio data.

Server applies an image processing library to normalize and clean each frame.

Input: raw image frames and raw audio segments produced in Step 3.

Server resizes each frame to a fixed resolution, converts color space, and normalizes pixel values to a predefined numeric range. Server applies noise reduction filters and optional brightness/contrast adjustment based on global statistics of the frame.

Server segments each audio stream into overlapping windows of a predetermined length, applies band-pass filtering, and computes spectral representations such as short-time Fourier transforms and Mel-frequency cepstral coefficients.

By transforming raw pixels and waveforms into standardized, noise-reduced representations, server produces data that can be processed efficiently by downstream models with fewer numerical instabilities.

Output: normalized image frames and numeric audio feature vectors, each aligned with timestamps.

### Step 5

Server detects and tracks human regions in the image stream.

Server applies an object detection network to identify regions containing people in each normalized frame.

Input: normalized image frames from Step 4.

Server passes each frame through a convolutional detection network that outputs bounding boxes and confidence scores. Server filters detections using a threshold, retains high-confidence human regions, and discards noise.

Server then applies a tracking algorithm that links detections across consecutive frames by comparing positions and appearance descriptors, thereby assigning a persistent track identifier to each person.

This processing converts per-frame detections into continuous tracks representing individuals across time.

Output: for each timestamp, a list of human regions with bounding boxes, track identifiers, and associated frame references.

### Step 6

Server extracts facial and body regions and computes visual features.

Server identifies the face and body portions within each human region.

Input: human-region bounding boxes and track identifiers from Step 5.

Server runs a face localization model on each human region to estimate positions of facial landmarks and uses them to crop and align a facial image patch. Server also defines a body region based on the bounding box geometry to cover torso and limbs.

Server feeds the facial patch into a facial emotion recognition network to obtain facial feature quantities, such as a vector of emotional category scores and intermediate feature embeddings. Server feeds the body region into a pose or action recognition network to obtain posture feature quantities, such as joint coordinates or activity scores.

By computing these feature vectors, server transforms high-dimensional pixel arrays into compact numeric representations that are invariant to translation and scale and more suitable for sequential analysis.

Output: for each track and timestamp, a set of facial feature vectors and posture feature vectors.

### Step 7

Server extracts linguistic and acoustic emotion features from audio.

Server processes the audio segments aligned with the image timestamps.

Input: audio feature vectors and raw audio segments from Step 4.

Server applies a speech recognition engine to the audio segments to produce utterance content information with time-aligned words or phonemes. Server then applies an emotion estimation module that receives acoustic features and text tokens and outputs voice emotion feature quantities and utterance manner feature quantities, such as speaking rate, pitch variability, and emphasis scores.

Server aligns these extracted features with the timestamps used for image tracks, based on the recorded time information.

Output: for each time interval, an audio feature sequence containing emotion and manner feature vectors and associated text fragments.

### Step 8

Server fuses visual and audio features into multimodal sequences.

Server associates each track with the corresponding audio features in the same time intervals.

Input: facial feature vectors and posture feature vectors from Step 6, and audio feature vectors and utterance content from Step 7.

Server constructs a multimodal feature vector for each track and timestamp by concatenating or otherwise combining the visual and audio feature vectors. Server normalizes each dimension across a batch using stored mean and variance to avoid scale imbalance.

Server writes these multimodal vectors into an ordered structure such as an array or list indexed by track identifier and time.

Output: for each track, a multimodal feature sequence representing combined emotional and behavioral characteristics over time.

### Step 9

Server estimates emotional states, behavioral states, and bullying risk via time-series modeling.

Server processes the multimodal feature sequences using a time-series analysis model.

Input: multimodal feature sequences generated in Step 8.

Server feeds each sequence into a recurrent neural network or a transformer-based sequence model that has been trained to output, for each time window, predicted emotional states, behavioral states, and a bullying-risk score. The model computes internal hidden states that capture temporal dependencies and aggregates evidence across multiple frames and audio segments.

Server then calibrates the raw risk scores using a post-processing function to obtain probability information or risk evaluation information between zero and one.

This temporal modeling allows server to distinguish transient noise from sustained or escalating patterns of concern, thereby improving detection accuracy and reducing false alerts.

Output: for each track and time window, emotional-state labels, behavioral-state labels, and bullying-risk probability values.

### Step 10

Server generates structured event information when risk exceeds a threshold.

Server monitors the risk probability for each track.

Input: emotional states, behavioral states, and risk evaluation information from Step 9.

Server determines whether the risk probability remains above a configurable threshold for a minimum duration or co-occurs with specific combinations of emotional and behavioral states. When such conditions are met, server creates a structured event record that includes identifiers, time range, location, dominant emotions, dominant behaviors, example transcript segments, and the final risk score.

Server may select representative frames and text excerpts that best illustrate the detected pattern, and associates them with the event record.

Output: structured event information objects representing individual suspected bullying incidents.

### Step 11

Server constructs a prompt sentence for a generative AI model.

Server converts each structured event record into a textual description suitable for input to a generative AI model.

Input: structured event information from Step 10.

Server inserts event fields into a predefined template or concatenates short clauses describing role, time period, location, emotional states, behavioral states, and speech analysis results.

For example, server may generate the following prompt sentence:

“Event data: child_role=victim, time_range=10:20-10:23, location=playground, visual_emotions={sad:0.82, fear:0.64}, behaviors={‘surrounded_by_peers’, ‘avoiding_eye_contact’}, speech_analysis={‘insults_detected':true}. Generate a concise explanation of what likely happened and propose concrete countermeasures for teachers and guardians in simple English.”

Output: a prompt sentence, together with optional encoded event metadata, to be supplied to a generative AI model.

### Step 12

Server obtains natural-language explanations and response plans from the generative AI model.

Server sends the constructed prompt sentence to the generative AI model and receives generated text.

Input: prompt sentence and structured event information from Step 11.

Server establishes a programmatic connection to the generative AI service, transmits the prompt sentence as input, and specifies generation parameters such as maximum length and style constraints. The generative AI model returns text that may include an interpretation of the event, a warning message suitable for a guardian or educational worker, and suggested response actions.

Server reviews the generated text programmatically, optionally truncates or reformats it, and attaches it to the corresponding event record as explanatory information and response plan data.

Output: text information including explanation, warning content, and one or more response plans for each event.

### Step 13

Server prepares and sends notification information to terminals.

Server transforms the text information into a format suitable for display and transmission.

Input: text information and structured event information produced in Step 12.

Server composes a notification payload containing a concise title, a brief summary derived from the explanation, a risk indicator, and links or identifiers for accessing full details. Server serializes the payload into a protocol-specific format and addresses it to the terminal associated with a guardian or educational worker.

Server transmits the payload through a push-notification service or another communication mechanism, and logs the delivery attempt and result.

Output: notification messages delivered to one or more terminals.

### Step 14

Terminal displays notifications and detailed incident information.

Terminal receives notification messages from the server and presents them to the user.

Input: notification messages from Step 13.

Terminal invokes the operating system notification interface to display a summary message and, upon user interaction, launches an application screen showing detailed explanation, risk level, event time and location, proposed response plans, and optionally representative images or transcript snippets.

Terminal allows the user to scroll, filter, and inspect the information, and provides interactive elements such as buttons for confirming or rejecting the suggested interpretation.

Output: on-screen displays and user interface elements through which the user can understand and review the detected event.

### Step 15

User reviews the event and provides feedback.

User reads the explanation and examines the incident details on the terminal.

Input: incident details displayed by the terminal in Step 14.

User determines, based on personal knowledge and additional context, whether bullying actually occurred, whether the system interpretation is correct, and what actions were taken. User then selects a label such as “confirmed bullying,” “no bullying,” or “uncertain,” and may enter textual comments describing the real situation or follow-up actions.

Output: review information and label information entered into the terminal's user interface.

### Step 16

Terminal transmits user feedback to the server.

Terminal packages the user's selections and comments into a structured feedback message.

Input: review information and label information from Step 15.

Terminal associates the feedback with the identifier of the corresponding event and sends the feedback message to the server over a secure communication channel.

Terminal may confirm receipt and show the user that the feedback has been stored successfully.

Output: feedback packets containing labels and comments delivered to the server.

### Step 17

Server stores feedback and updates learning data.

Server integrates the received feedback into its data storage.

Input: feedback packets from Step 16 and stored structured event information and feature sequences from prior steps.

Server links the feedback to the matching event record using event identifiers and attaches the user label and comments. Server then creates or updates training entries that pair multimodal feature sequences and model outputs with the user-specified labels.

Server stores these training entries in a repository partitioned into sets for training, validation, and testing as appropriate for subsequent model updating.

Output: an expanded learning dataset containing feature sequences, risk scores, and ground-truth labels.

### Step 18

Server retrains or fine-tunes internal models based on accumulated data.

Server periodically or conditionally initiates a model update procedure.

Input: learning dataset produced in Step 17 and current model parameters.

Server constructs training batches from the stored feature sequences and labels, feeds them through the emotion recognition networks, posture networks, and time-series analysis model, and computes loss values representing disagreement between predicted outputs and user-provided labels. Server calculates gradients of these loss functions with respect to model parameters and applies an optimization algorithm to update weights.

Server may adjust decision thresholds and risk-calculation parameters based on validation set performance, thereby refining the criteria used in Step 10 to trigger event creation.

Output: updated model parameters and configuration values that improve detection accuracy and reduce false alarms.

### Step 19

Server optionally refines prompt generation strategy using model performance and feedback.

Server evaluates the effectiveness of generated warning messages and response plans.

Input: historical event records, text information, user feedback, and updated model configurations.

Server analyzes which types of prompt sentences and generated messages led to correct user interpretations and useful actions. Based on this analysis, server modifies the templates or rules used in Step 11, for example by including additional context fields or adjusting the requested style and level of detail.

Server thus adapts the prompt generation strategy so that future interactions with the generative AI model produce text that is better aligned with real-world needs and internal risk evaluations.

Output: revised prompt-generation rules and templates that enhance the quality and utility of generative AI outputs.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

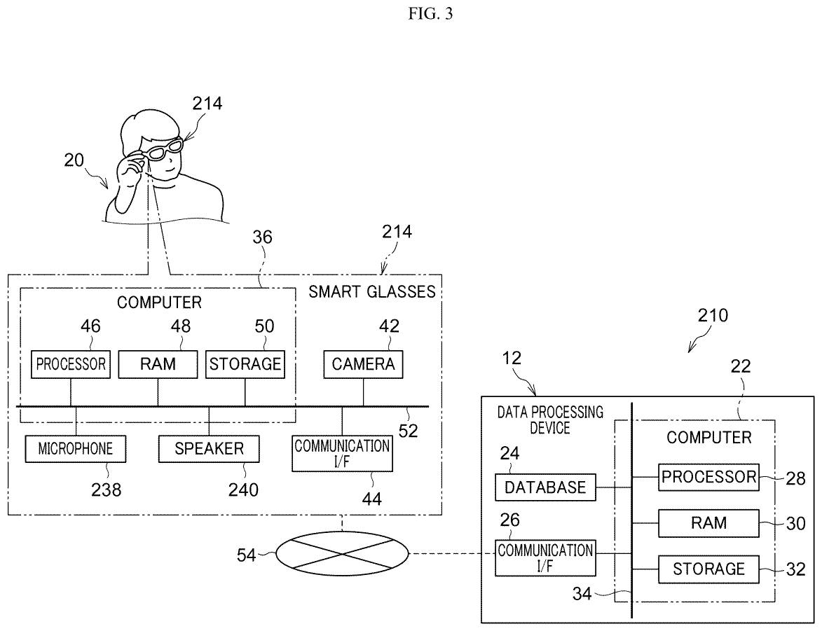

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

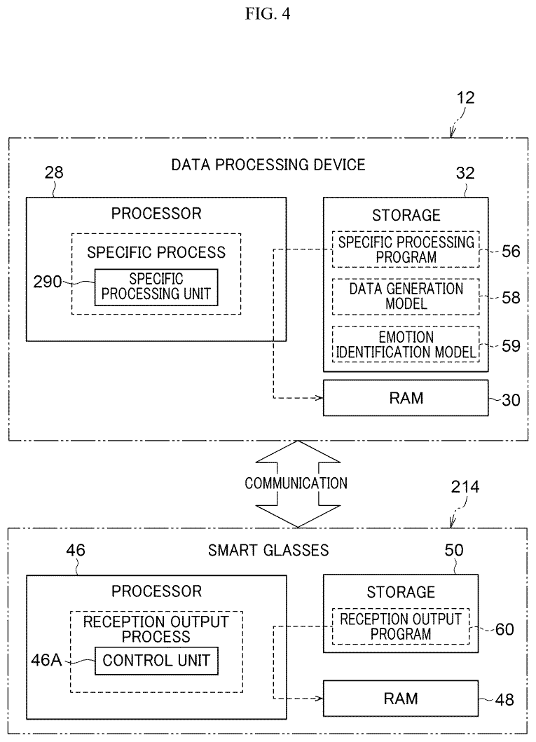

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

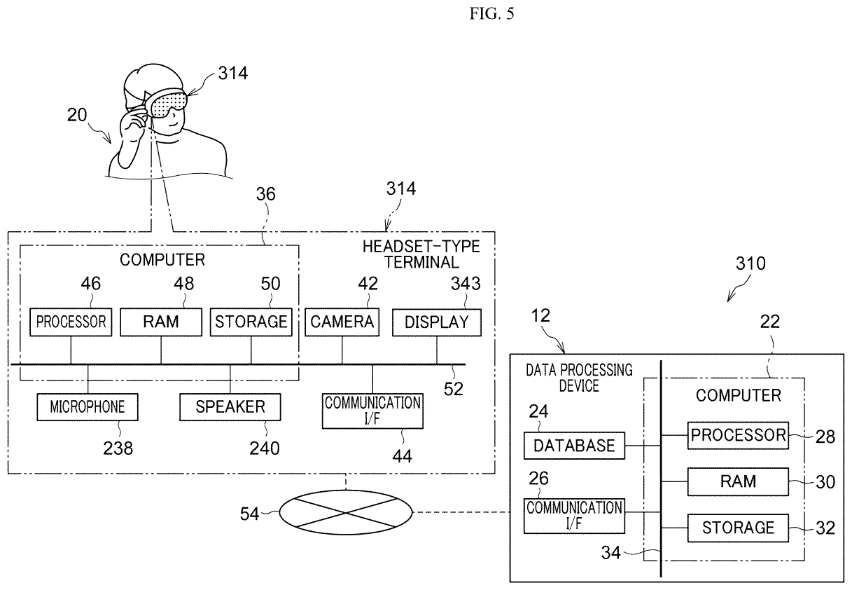

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

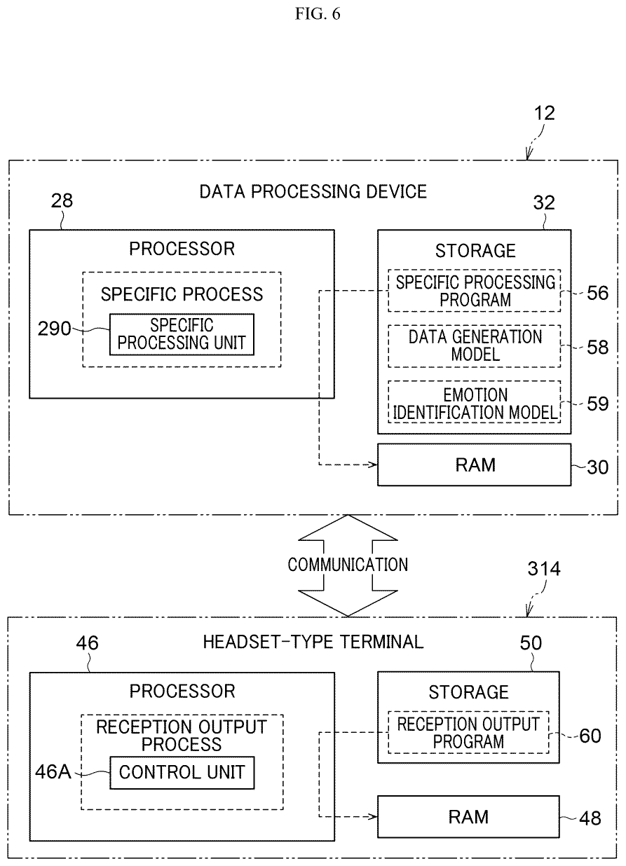

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

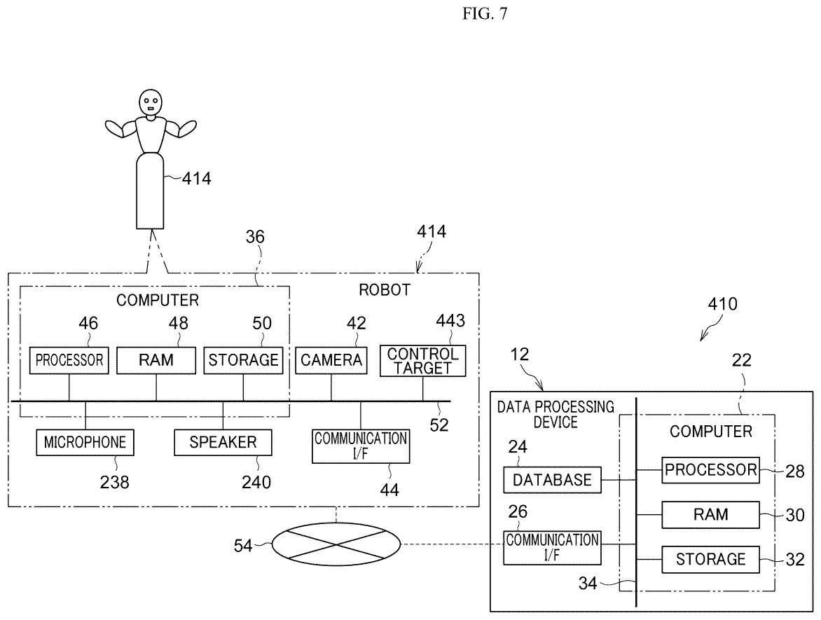

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

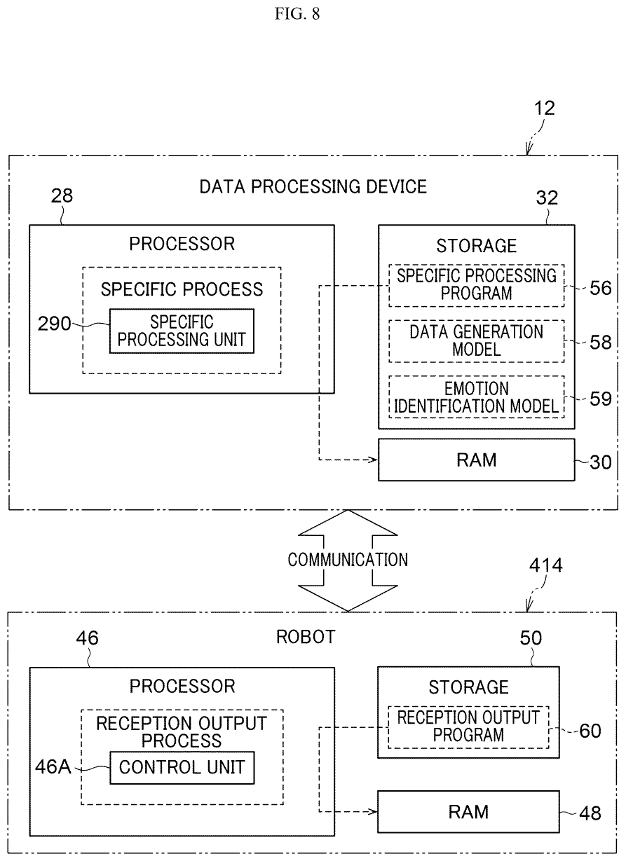

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

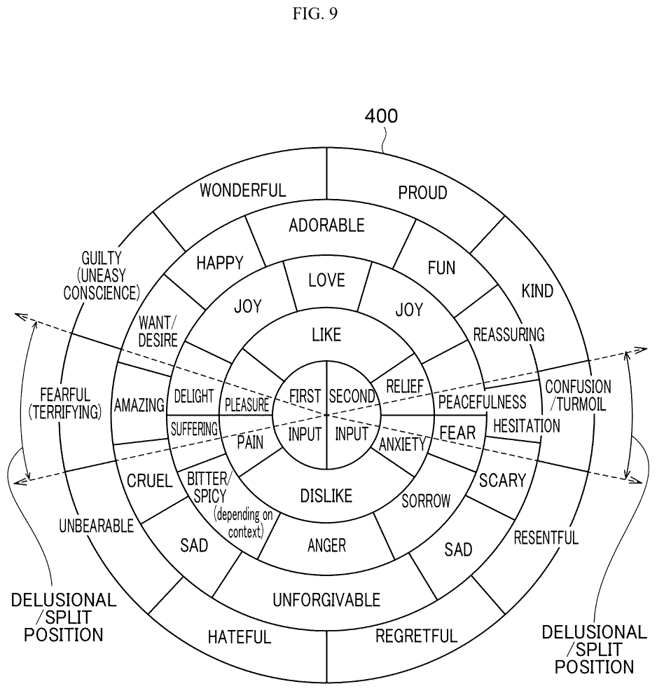

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

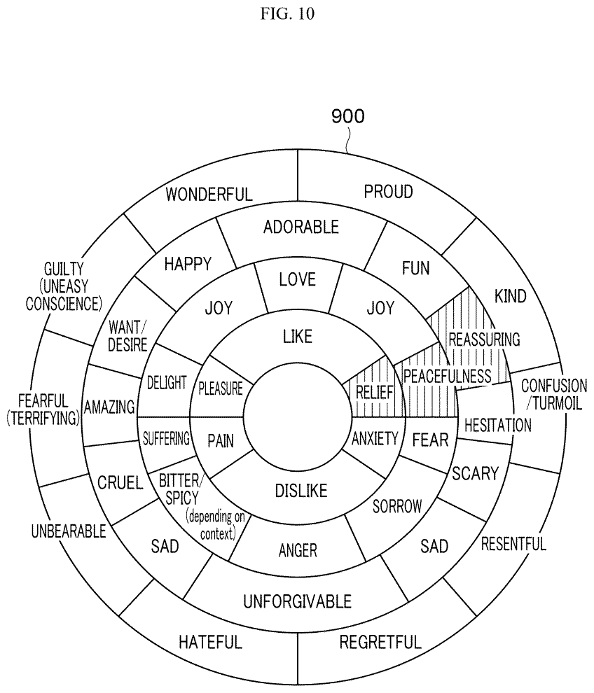

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
control an image acquisition device to acquire imaging information of a subject and transmit the imaging information to an information processing apparatus via a communication path,
extract a facial region and a body region of the subject from the imaging information in the information processing apparatus, perform expression analysis processing on the facial region,
perform posture estimation processing and motion recognition processing on the body region, and calculate a risk index related to a possibility of bullying by temporally integrating feature quantities relating to interactions between subjects based on analysis results,
generate a natural language prompt sentence from structured data describing a situation when the risk index satisfies a predetermined criterion, supply the prompt sentence as input to a generative AI model, and generate notification information including a warning message and concrete countermeasures based on a response sentence obtained from the generative AI model in the information processing apparatus,
transmit the notification information to a user display device and enable the user display device to display the warning message, the countermeasures, and a summary of the analysis results in the information processing apparatus, and
associate feedback information input from a user with the analysis results, record the feedback information and the analysis results, and periodically execute a learning process to update at least one of a discrimination model used to calculate the risk index related to the possibility of bullying and processing for generating the prompt sentence, based on the record, in the information processing apparatus.

### Supplementary 2

The system according to supplementary 1,
wherein the processor is configured to
aggregate the analysis results, the risk index, the notification information, and the feedback information, generate a management screen that lists these in time series and includes a link to a reference position of the imaging information, and provide the management screen as an interface accessible by a guardian or an educational personnel via the user display device in the information processing apparatus.

### Supplementary 3

The system according to supplementary 1,
wherein the processor is configured to
use, as training data in the learning process, an expression analysis result, a motion recognition result, the risk index, the notification information, and the feedback information for the imaging information, automatically adjust at least one of a model configuration and a threshold when an evaluation index of the discrimination model does not satisfy a predetermined criterion, and dynamically update a condition for issuing the warning message and contents of generation of the prompt sentence in the information processing apparatus.

### Application Example 1

### Supplementary 1

A system comprising a processor,
wherein the processor is configured to
receive time-series image information acquired from a portable information processing apparatus and temporarily store the time-series image information,
extract a person region from the time-series image information, calculate feature information representing an emotional state and a motion state for the person region, and aggregate the feature information for each predetermined time window to generate structured information,
generate, in a natural language, a prompt sentence for evaluating a possibility of bullying based on the structured information, input the prompt sentence to a generative information processing model, and cause the generative information processing model to output evaluation information and explanation information regarding the possibility of bullying,
determine whether the evaluation information satisfies a predetermined threshold condition, and, in a case where the threshold condition is satisfied, generate warning information including a detection time, identification information, and the explanation information, and transmit the warning information as notification information to the portable information processing apparatus, and
store the evaluation information and the warning information in association with a recording medium, and provide the stored information for later viewing.

### Supplementary 2

The system according to supplementary 1,
wherein the processor is configured to provide an information display screen capable of displaying contents of the notification information transmitted to the portable information processing apparatus, receive, via the information display screen, user evaluation information indicating appropriateness or inappropriateness of the warning information, and store the received user evaluation information in association with the recording medium.

### Supplementary 3

The system according to supplementary 1,
wherein the processor is configured to perform performance evaluation on at least one of a discrimination model for calculating the feature information and the generative information processing model, based on the stored user evaluation information and the time-series image information, and to periodically execute a learning process of the model or an adjustment process of the threshold condition based on a result of the performance evaluation.

### Example 2

### Supplementary 1

A system comprising a processor,
wherein the processor is configured to
acquire, from a biological information acquisition device, image information and acoustic information of a child, and record the image information and the acoustic information in association with time information and position information,
analyze the image information by using image analysis technology to detect a face region, extract an expression state and a body motion state, and convert the expression state and the body motion state into structured data as behavior information aggregated on a time basis,
analyze the acoustic information by using speech analysis technology to convert a speech content into character information, calculate an emotion state and an aggressiveness index, and convert the emotion state and the aggressiveness index into structured data as conversation information aggregated on a time basis,
associate the expression state, the body motion state, and the conversation information with the time information and the position information to generate integrated event information indicating an interaction event between children for each predetermined time interval,
convert the integrated event information into a description text in natural language, generate a prompt sentence including the description text, input the prompt sentence into a generative information processing model, obtain an evaluation value indicating a possibility of bullying and an explanation of a reason for the evaluation value, and classify the integrated event information into a risk level based on the evaluation value,
input, into the generative information processing model, a prompt sentence including the risk level and the integrated event information, and cause the generative information processing model to generate, in natural language, a notification message including a warning text and behavioral guidelines according to a state of the child, a detected behavior, and a conversation content, and
transmit the notification message to an information processing terminal of a guardian and an educational worker, and present the warning text and the behavioral guidelines so as to be viewable on the information processing terminal.

### Supplementary 2

The system according to supplementary 1,
wherein the processor is configured to
generate an information presentation screen that enables a chronological list display of the integrated event information, the evaluation value, the risk level, and the notification message, and provide a management display function that allows the guardian and the educational worker, through the information presentation screen, to view analysis results relating to the possibility of bullying in past and current periods and to set or change a threshold and a notification condition.

### Supplementary 3

The system according to supplementary 1,
wherein the processor is configured to
record the evaluation value and the risk level in association with post-response information and feedback information acquired from the guardian and the educational worker, automatically update components and an expression format of the prompt sentence to be input into the generative information processing model based on the record, and adjust a determination condition and a threshold used for calculation of the evaluation value, thereby executing learning control processing for improving detection accuracy of the possibility of bullying and usefulness of the notification message.

### Application Example 2

### Supplementary 1

A system comprising a processor,
wherein the processor is configured to
receive time-series image information and acoustic information obtained from an observation device, perform preprocessing on the image information by an image processing technique to normalize pixel information, and perform preprocessing on the acoustic information by a signal processing technique to extract voice features in a time domain or a frequency domain,
detect a human region from the preprocessed image information by using an object recognition algorithm and a tracking algorithm, associate the human region with time-series positions, and
generate feature information with individual identification information,
extract a facial region and a body region from the human region, extract facial feature quantities and posture feature quantities by using a machine learning model, and generate a behavior feature sequence by aggregating the feature quantities in a time direction,
perform a speech recognition process and an emotion estimation process on the acoustic information to extract utterance content information, voice emotion feature quantities, and utterance manner feature quantities of a speaker, and generate an audio feature sequence in a time series,
integrate the behavior feature sequence and the audio feature sequence, estimate a plurality of emotional states and behavioral states of a child over time by using a time-series analysis model, and calculate probability information or risk evaluation information indicating a possibility of bullying based on an estimation result,
generate structured event information regarding a situation when the probability information or the risk evaluation information satisfies a predetermined condition, and automatically generate a prompt sentence to be input to a generative AI model based on the structured event information,
input the prompt sentence and the structured event information to the generative AI model, and generate text information including explanatory information regarding the possibility of bullying, a warning message, and at least one response plan by natural language processing,
convert the text information into notification information to be transmitted to a user display device, and transmit the notification information to a terminal device of a guardian or an educational worker, and
store review information or label information input from the terminal device in association with the structured event information and the probability information or the risk evaluation information, and reuse the stored information as learning data for the machine learning model and the time-series analysis model so as to form a self-learning loop for continuously improving detection accuracy of the possibility of bullying.

### Supplementary 2

The system according to supplementary 1,
wherein the processor is configured to
organize and visualize the text information, the probability information or the risk evaluation information, and the structured event information in chronological order, generate a management screen that enables list display of state transitions of each child, transitions of risk levels, and past response plans, and provide a display control interface that enables access to the management screen from the terminal device of the guardian or the educational worker.

### Supplementary 3

The system according to supplementary 1,
wherein the processor is configured to
calculate control parameters for dynamically adjusting urgency, expression intensity, and content of the response plan of the warning message according to the probability information or the risk evaluation information, the emotional states, the behavioral states, and the review information or the label information, and optimize input content to the generative AI model by including the control parameters in generation of the prompt sentence.

What is claimed is:

1. A system comprising:
circuitry configured to:
receive, via a communication interface coupled to a packet-switched network, time-series sensor data from a terminal device;
extract, from the time-series sensor data, a plurality of region segments corresponding to detected subjects;
perform, on respective region segments of the plurality of region segments, a first feature extraction process and a second feature extraction process to generate a first feature sequence and a second feature sequence;
temporally integrate the first feature sequence and the second feature sequence over a sliding time window to generate an interaction feature vector representing co-occurring states across the detected subjects;
apply a discrimination model to the interaction feature vector to calculate a risk index;
generate, responsive to the risk index satisfying a threshold condition, structured event data encoding at least the risk index, a time interval, and an identification parameter;
construct a natural language prompt from the structured event data;
input the natural language prompt to a neural network generative model and obtain a response comprising notification content and at least one action recommendation;
transmit the notification content and the at least one action recommendation to the terminal device via the communication interface; and
associate feedback data received from the terminal device with the structured event data and the risk index, and periodically execute a learning process that updates at least one of the discrimination model and a prompt generation configuration based on the associated feedback data.

2. The system according to claim 1, wherein the first feature extraction process comprises applying a convolutional neural network to each region segment to generate an emotion probability vector, and wherein the second feature extraction process comprises applying a keypoint detection model to each region segment to generate a sequence of body pose coordinate vectors.

3. The system according to claim 2, wherein temporally integrating the first feature sequence and the second feature sequence comprises classifying temporal patterns across sequential frames of the emotion probability vectors and the body pose coordinate vectors to produce interaction state labels for pairs of detected subjects within the sliding time window.

4. The system according to claim 3, wherein the interaction feature vector comprises a concatenation of the interaction state labels, a count of co-occurring interaction state labels of a predetermined type within the sliding time window, and a duration measure for each co-occurring interaction state.

5. The system according to claim 4, wherein the discrimination model comprises at least one of a gradient-boosted decision tree ensemble and a feedforward neural network trained on labeled interaction feature vectors, and wherein the risk index is a scalar value normalized to a predetermined range.

6. The system according to claim 1, wherein the circuitry is further configured to, responsive to the risk index exceeding a second threshold higher than the threshold condition, transmit a control signal via the communication interface to at least one of: an image acquisition device to activate a high-resolution recording mode for a region associated with the detected subjects; a second terminal device different from the terminal device to deliver an escalated alert data packet; or an environmental control device to modify an operational parameter of an environment in which the detected subjects are located.

7. The system according to claim 1, wherein the learning process comprises:
computing a loss function between predicted risk indices generated by the discrimination model and label values derived from the feedback data;
applying gradient-based optimization to update weight parameters of the discrimination model; and
adjusting the threshold condition based on a statistical distribution of the risk indices computed over a preceding time period.

8. The system according to claim 7, wherein the learning process further comprises modifying at least one prompt template used to construct the natural language prompt, based on a correlation between the feedback data and effectiveness scores assigned to previously generated action recommendations.

9. The system according to claim 1, wherein the circuitry is further configured to:
receive audio data from an audio acquisition device via the communication interface;
apply a speech recognition model to the audio data to generate transcribed text segments; and
compute at least one of an emotion classification score and an aggressiveness index from the audio data using an acoustic feature analysis model.

10. The system according to claim 9, wherein the structured event data further encodes the emotion classification score, the aggressiveness index, and the transcribed text segments, and wherein the natural language prompt incorporates the emotion classification score and the aggressiveness index as numerical parameters.

11. The system according to claim 10, wherein the circuitry is further configured to construct a second natural language prompt incorporating the transcribed text segments and a set of behavioral guideline data retrieved from the data store, input the second natural language prompt to the neural network generative model, and obtain a second response comprising context-specific guidance content for transmission to the terminal device.

12. The system according to claim 1, wherein the circuitry is further configured to preprocess the time-series sensor data by:
normalizing image frame data to a standard resolution and color space;
normalizing audio sample data to a standard sampling rate and amplitude range; and
synchronizing timestamps of the image frame data and the audio sample data to a common time reference.

13. The system according to claim 12, wherein extracting the plurality of region segments comprises applying an object detection model to each normalized image frame to generate bounding region coordinates and a confidence score for each detected subject, and tracking each detected subject across consecutive image frames using a multi-object tracking algorithm that maintains a persistent identification parameter for each detected subject.

14. The system according to claim 13, wherein the first feature extraction process and the second feature extraction process are applied to cropped image regions defined by the bounding region coordinates, and wherein the first feature sequence and the second feature sequence are indexed by the persistent identification parameter.

15. The system according to claim 14, wherein temporally integrating the first feature sequence and the second feature sequence comprises inputting a concatenated feature tensor spanning the sliding time window to a time-series analysis model comprising at least one of a long short-term memory network and a transformer encoder to generate the interaction feature vector.

16. The system according to claim 15, wherein the circuitry is further configured to execute a self-learning loop comprising:
accumulating the structured event data and corresponding feedback data over a plurality of evaluation cycles;
retraining at least one of the discrimination model, the time-series analysis model, and the object detection model using the accumulated structured event data and feedback data; and
deploying updated model parameters to replace prior model parameters after a validation accuracy metric exceeds a predetermined acceptance threshold.

17. The system according to claim 16, wherein the circuitry is further configured to dynamically adjust at least one of a frame sampling rate of the image frame data, a sensitivity parameter of the object detection model, and a length of the sliding time window based on the risk index computed over a preceding interval.

18. A system comprising:
circuitry configured to:
receive, via a communication interface coupled to a packet-switched network, image frames captured by an image acquisition device at a terminal device;
apply a detection model to the image frames to generate bounding regions with confidence scores identifying detected subjects;
extract, for each detected subject, emotion probability vectors from facial region data using a convolutional neural network, and temporally ordered action labels from body region data using a pose estimation model;
align the emotion probability vectors and the temporally ordered action labels in time and spatial coordinates across the detected subjects to produce a fused temporal feature representation;
apply a discrimination model to the fused temporal feature representation to compute a risk index;
responsive to the risk index satisfying a threshold, generate structured event data and construct a prompt for a generative model implemented as a transformer architecture;
obtain, from the generative model, notification content and action recommendation data; and
execute a model update process that adjusts parameters of at least one of the discrimination model and the generative model based on feedback data received via the communication interface.

19. The system according to claim 18, wherein the circuitry is further configured to generate a dashboard data structure comprising a time-series aggregation of risk indices, event counts per time interval, and identifiers of detected subjects, and to transmit the dashboard data structure to the terminal device for rendering on a management interface.

20. A method performed by circuitry, the method comprising:
receiving, via a communication interface coupled to a packet-switched network, time-series sensor data from a terminal device;
extracting a plurality of region segments corresponding to detected subjects from the time-series sensor data;
performing a first feature extraction process and a second feature extraction process on respective region segments to generate a first feature sequence and a second feature sequence;
temporally integrating the first feature sequence and the second feature sequence over a sliding time window to generate an interaction feature vector;
applying a discrimination model to the interaction feature vector to calculate a risk index;
generating structured event data responsive to the risk index satisfying a threshold condition;
constructing a natural language prompt from the structured event data, inputting the natural language prompt to a neural network generative model, and obtaining notification content and at least one action recommendation;
transmitting the notification content and the at least one action recommendation to the terminal device; and
associating feedback data with the structured event data and executing a learning process that updates at least one of the discrimination model and a prompt generation configuration.
